(19) United States
(12) Patent Application Publication
(10) Pub. No.: US 2022/0309460 A1
(43) Pub. Date: Sep. 29, 2022

(54) SERVER APPARATUS, SYSTEM, AND INFORMATION PROCESSING METHOD

(71) Applicants: Jun MURATA, Tokyo (JP); Katsuyuki KAJI, Tokyo (JP); Xiaonan JIANG, Kanagawa (JP)

(72) Inventors: Jun MURATA, Tokyo (JP); Katsuyuki KAJI, Tokyo (JP); Xiaonan JIANG, Kanagawa (JP)

(21) Appl. No.: 17/694,676

(22) Filed: Mar. 15, 2022

(30) Foreign Application Priority Data
Mar. 23, 2021 (JP) 2021-048515
Dec. 28, 2021 (JP) 2021-214831

(51) Int. Cl. G06Q 10/08; G06V 30/412

(52) U.S. Cl. CPC G06Q 10/0875; G06V 30/412

(57) ABSTRACT

An apparatus, system, and method, each of which stores information on a plurality of forms issued by a first user, generates transfer data indicating a transfer of an item from a second user to the first user based on a particular form of the plurality of forms, the transfer data including an identifier of the particular form, and transmits the transfer data to a second terminal operated by the second user to cause the second user to transfer the item to the first user using the transfer data.

### CROSS-REFERENCE TO RELATED APPLICATIONS

This patent application is based on and claims priority pursuant to 35 U.S.C. § 119(a) to Japanese Patent Application Nos. 2021-048515, filed on Mar. 23, 2021, and 2021-214831, filed on Dec. 28, 2021, in the Japan Patent Office, the entire disclosure of which is hereby incorporated by reference herein.

### BACKGROUND

### Technical Field

The present disclosure relates to a server apparatus, a system, and an information processing method.

### Related Art

For example, there is a service provider that provides a service to assist a user in creating a plurality of forms, and manage the plurality of forms issued by the user to another user. While such form can be further used by another user, information on the plurality of forms, managed by the service provider, has not been used so efficiently.

### SUMMARY

Example embodiments include a server apparatus including a memory that stores information on a plurality of forms issued by a first user, and circuitry that generates transfer data indicating a transfer of an item from a second user to the first user based on a particular form of the plurality of forms, the transfer data including an identifier of the particular form, and transmits the transfer data to a second terminal operated by the second user to cause the second user to transfer the item to the first user using the transfer data.

Example embodiments include a system including a memory that stores information on a plurality of forms issued by a first user, and circuitry that generates transfer data indicating a transfer of an item from a second user to the first user based on a particular form of the plurality of forms, the transfer data including an identifier of the particular form, and transmits the transfer data to a second terminal operated by the second user to cause the second user to transfer the item to the first user using the transfer data.

Example embodiments include an information processing method including: storing information on a plurality of forms issued by a first user; generating transfer data indicating a transfer of an item from a second user to the first user based on a particular form of the plurality of forms, the transfer data including an identifier of the particular form; and transmitting the transfer data to a second terminal operated by the second user to cause the second user to transfer the item to the first user using the transfer data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a communication system according to the embodiments:

FIG. 2 is a hardware configuration diagram of a terminal or a server in the communication system of FIG. 1 according to the embodiment;

FIG. 3 is a diagram illustrating relationships between companies, as entities implementing the communication system of FIG. 1, according to an embodiment;

FIG. 4 is a block diagram illustrating a functional configuration of the communication system of FIG. 3 according to the embodiment;

FIG. 5 is a conceptual diagram illustrating an example of tenant information management table:

FIG. 6 is a conceptual diagram illustrating an example of payer account information management table;

FIG. 7 is a conceptual diagram illustrating an example of invoice information management table;

FIG. 8 is a conceptual diagram illustrating an example of transaction information management table;

FIG. 9 is a sequence diagram illustrating processing of transmitting a reception screen that allows access to an invoice, according to the embodiment;

FIG. 10 is a sequence diagram illustrating processing of displaying a receipt screen according to the embodiment;

FIG. 11 is a flowchart illustrating processing of generating a receipt screen according to the embodiment;

FIG. 12 is an illustration of an example receipt screen displayed when the payer account information is not registered;

FIG. 13 is an illustration of an example receipt screen displayed when the payer account information is registered:

FIG. 14 is a sequence diagram illustrating processing of acquiring an invoice image according to the embodiment;

FIG. 15 is a sequence diagram illustrating example operation to process a request for downloading transfer data;

FIG. 16 is a sequence diagram illustrating another example operation to process a request for downloading transfer data;

FIG. 17 is a sequence diagram illustrating another example operation to process a request for downloading transfer data;

FIG. 18 is an illustration of an example account information registration screen:

FIG. 19 is an illustration of an account information update screen;

FIG. 20 is a sequence diagram illustrating example processing of downloading transfer data;

FIG. 21 is a diagram illustrating an example of transfer data;

FIG. 22 is a sequence diagram illustrating processing of reconciling transactions according to the embodiment;

FIG. 23 is a transition diagram of the transaction information management table, according to the embodiment;

FIG. 24 is a flowchart illustrating automatic reconciliation process, according to the embodiment:

FIG. 25 is an illustration of an example automatic reconciliation result screen;

FIG. 26 is a flowchart illustrating processing of generating a receipt screen according to a modified example;

FIG. 27 is an illustration of an example receipt screen according to the modified example;

FIG. 28 is an illustration of an example account information registration screen according to the modified example;

FIG. 29 is an illustration of an example account information registration screen according to the modified example;

FIG. 30 is an illustration of an example offset input screen;

FIG. 31 is a conceptual diagram illustrating an example of invoice detail information management table;

FIG. 32 is a conceptual diagram of an example of transaction information management table, according to the modified example;

FIG. 33 is a diagram illustrating an example of transfer data, according to the modified example;

FIGS. 34A and 34B (FIG. 34) are a flowchart illustrating automatic reconciliation process according to the modified example;

FIG. 35 is an illustration of an example automatic reconciliation result screen according to the modified example;

FIG. 36 is an illustration of an example invoice check screen, according to the modified example;

FIG. 37 is an illustration of an example receipt screen specific to a particular business partner according to a modified example:

FIG. 38 is a diagram illustrating an example of transfer data, according to the modified example;

FIG. 39 is a flowchart illustrating automatic reconciliation process according to the modified example;

FIG. 40 is an illustration of an example offset information input screen according to a modified example; and

FIG. 41 is a diagram illustrating an example of transfer data, according to the modified example.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a.” “an,” and “the” are intended to include the plural forms as well, unless the context clearly indicates otherwise.

Overview of Communication System

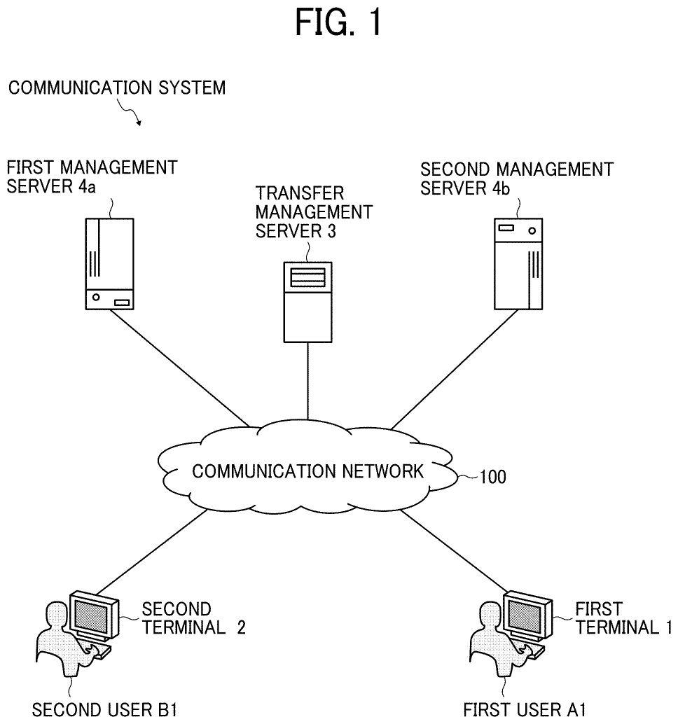

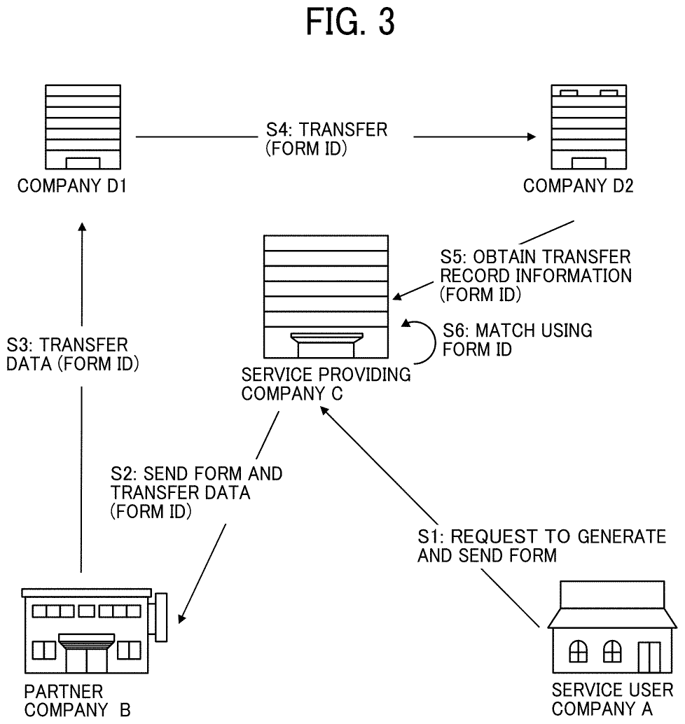

FIG. 1 is a schematic diagram illustrating a configuration of a communication system according to the embodiments. Specifically, FIG. 1 is a diagram illustrating a terminal or a server provided at each entity, for example, at each company in as illustrated in FIG. 3.

The communication system of FIG. 1 includes a first terminal 1 operated by a first user A1, a second terminal 2 operated by a second user B1, a first management server 4a, a second management server 4b, and a transfer management server 3, which are connected through a communication network 100.

In one embodiment, the transfer management server 3 stores, in a memory, information on a plurality of forms each issued by the first user A1. Each form may be generated by the transfer management server 3 in response to a request from the first user A1. The transfer management server 3 generates transfer data indicating a transfer of an item from a second user B1 to the first user A1 based on a particular form of the plurality of forms, such that the transfer data includes an identifier of the particular form. The transfer management server 3 transmits the transfer data to the second terminal 2.

Based on the transfer data that is received, the second terminal 2 transmits a request for transferring the item from the second user B1 to the first user A1, to the first management server 4a. The request includes the identifier of the particular form. In this example, the first management server 4a manages information on items of the second user B1. The second management server 4b manages information on items of the first user A1. The first management server 4a transfers the item to the second management server 4b, with information on the identifier of the particular form. The second management server 4b transmits transfer record information confirming the transfer of the item, with the identifier of the particular form, to the transfer management server 3.

The transfer management server 3 may determine whether the identifier of the particular form in the transfer data, and the identifier of the particular form in the transfer record information match. The transfer management server 3 may further determine whether information obtained from the particular form, identified with the matched identifier, and information obtained from the transfer record information having the matched identifier, match.

Hardware Configuration of Communication System

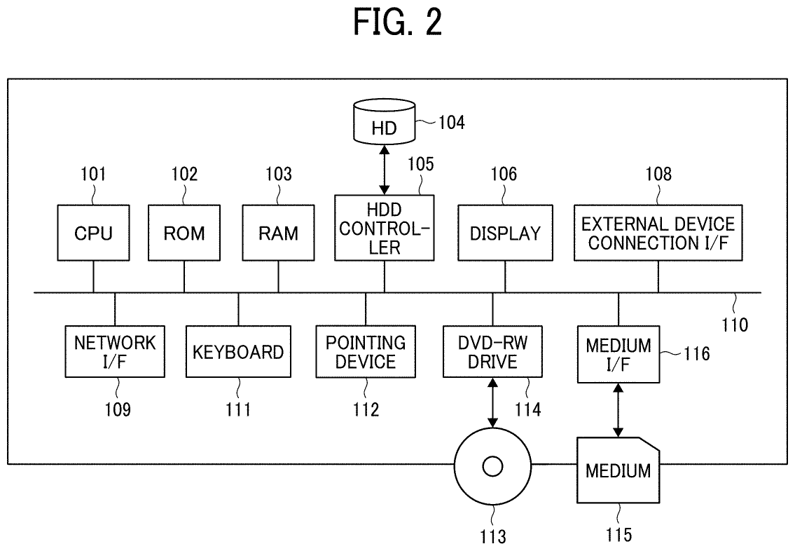

Next, referring to FIG. 2, hardware configurations of terminal and servers in the communication system illustrated in FIG. 1 will be described according to the embodiment. Since all of the terminal and the servers have the same hardware configuration, the hardware configuration of the first terminal 1 will be described as an example, and the description of the hardware configuration of each server is omitted.

As illustrated in FIG. 2, the first terminal 1, which is implemented by a computer, includes a central processing unit (CPU) 101, a read only memory (ROM) 102, a random access memory (RAM) 103, a hard disk (HD) 104, a Hard Disk Drive (HDD) controller 105, a display 106, an external device connection interface (I/F) 108, a network I/F 109, a bus line 110, a keyboard 111, a pointing device 112, a Digital Versatile Disk Rewritable (DVD-RW) drive 114, and a medium L/F 116.

Among them, the CPU 101 controls entire operation of the computer. The ROM 102 stores a program for executing the CPU 101 such as an initial program loader (IPL). The RAM 103 is used as a work area for the CPU 101. The HD 104 stores various data such as a control program. The HDD controller 105 controls reading or writing of various data from or to the HD 104 under control of the CPU 101. The display 106 displays various information such as a cursor, menu, window, character, and image. The external device connection i/F 108 is an interface for connecting the computer to various external devices. Examples of the external devices include, but not limited to, a universal serial bus (USB) memory and a printer. The network V/F 109 is an interface that controls communication of data with an external device through the communication network 100. The bus line 110 is, for example, an address bus or a data bus, which electrically connects the elements such as the CPU 101 illustrated in FIG. 2.

The keyboard 111 is one example of an input device provided with a plurality of keys for allowing a user to input characters, numerals, or various instructions. The pointing device 112 is an example of an input device that allows a user to select or execute a specific instruction, select a target for processing, or move a cursor being displayed. The DVD-RW drive 114 controls reading and writing of various data from and to a DVD-RW 113, which is an example of a removable recording medium. In alternative to the DVD-RW, any recording medium may be used such as a DVD-R, Blu-ray Disc (Registered Trademark), etc. The medium I/F 116 controls reading and writing (storing) of data from and to a recording medium 115 such as a flash memory.

The external device connection I/F may be connected to a microphone as an example of a sound collecting device, a speaker as an example of a sound output device, a camera as an example of an imaging device, etc.

In the following embodiments, the example case in which an invoice is used as the form is described. In such case, the item to transfer is money, in an amount indicated by the invoice.

Relationships Between Companies

Referring to FIG. 3, the relationships between companies, which are examples of entities, will be described according to embodiments. FIG. 3 is a diagram illustrating relationships between companies according to the embodiments. The companies include a service user company A, a business partner company B, a service providing company C, a first company D1, and a second company D2.

As illustrated in FIG. 3, the service user company A is a company that provides goods or services to the business partner company B, and receives compensation for the goods or services from the business partner company B. In this case, the service user company A is a creditor and the business partner company B is a debtor. For example, the business partner company B may be a customer of the service user company A, or a buyer of the goods or services provided by the service user company A.

The service providing company C is a company that provides a service for creating an invoice to be sent to the business partner company B on behalf of the service user company A, in response to a request from the service user company A.

The first company D1 may be a financial institution D1, such as a bank that manages a bank account of the business partner company B. The second company D2 may be a financial institution D2, such as a bank that manages a bank account of the service user company A.

The following describes an outline of transactions, performed by the entities of FIG. 3, according to the embodiments. In the following, ID is an example of identification information, which may be represented by any combination of characters, symbols, marks, and numbers.

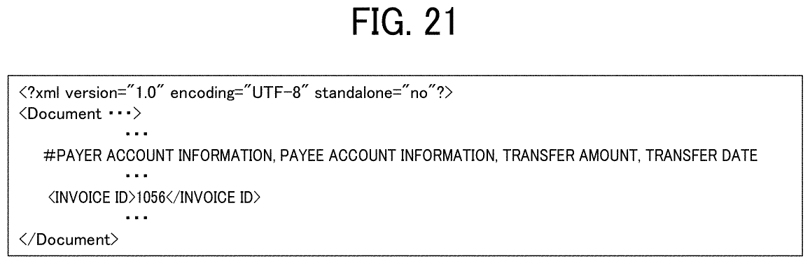

First, the service user company A requests the service providing company C to create an invoice and send the invoice to the business partner company (S1). The service providing company C creates the invoice and transfer data including the invoice ID of the invoice, and sends the transfer data to the business partner company B (S2). This transfer data is data used for transfer from the bank account of the business partner company B (buyer) to the bank account of the service user company A (seller) based on the invoice. The contents of the transfer data are illustrated in FIG. 21. That is, the service providing company C creates transfer data to be used by the business partner company B at the time of transfer, which includes the invoice ID of the invoice issued to the business partner company B.

Next, the business partner company B sends the transfer data including the invoice ID to the financial institution D1 (63). The financial institution D1 transfers the amount of money indicated by the transfer data to the financial institution D2 that manages the bank account of the service user company A (S4). At this time, the invoice ID is also sent to the financial institution D2.

Next, after confirming the transfer, the financial institution D2 sends transfer record information including transfer contents (such as a transfer source, a transfer destination, a transfer amount, and a transfer date) and the invoice ID to the service providing company C, so that the service providing company C acquires the transfer record information (S5).

Next, based on the invoice ID and the transfer contents included in the transfer record information, the service providing company C clears the accounts receivable specified by the invoice ID (S6). In this case, even if there is a plurality of invoices, the service providing company C is able to identify the invoice issuing the payment to be cleared using the invoice ID, and confirm whether or not the billing amount and the transfer amount match based on the transfer record information. If the invoice issuing the payment is identified with the invoice ID in the transfer record information, but the billing amount and the transfer amount do not match, the service providing company C does not clear the invoice, but performs a countermeasure such as notifying the business partner company B of inconsistency. In this disclosure, the process of matching the billing amount in the invoice and the transfer amount in the transfer record information (such as a bank record, or payment actually made) is considered as an example of reconciliation.

Referring back to FIG. 1, the example case in which the communication system of FIG. 1 is implemented by the example case of FIG. 3 is described.

The service user company A, which provides the services or goods, is provided with the first terminal 1, referred to as a seller terminal 1 such as a personal computer (PC), which is operated by a seller A1. The business partner company B is provided with the second terminal 2, referred to as a buyer terminal 2 such as a PC, which is operated by a buyer B1. The service providing company C is provided with the transfer management server 3, referred to as a transaction management server 3. The company D1, referred to as the financial institution D1, is provided with the first management server 4a, referred to as an account management server 4a that manages accounts for the buyer B1. The company D2, referred to as the financial institution D2, is provided with the second management server 4b, referred to as an account management server 4b that manages accounts for the seller A. Each server is implemented by one or more computers. The seller terminal 1, the buyer terminal 2, the transaction management server 3, the account management server 4a, and the account management server 4b communicate with each other via the communication network 10) such as the Internet.

Functional Configuration of Communication System

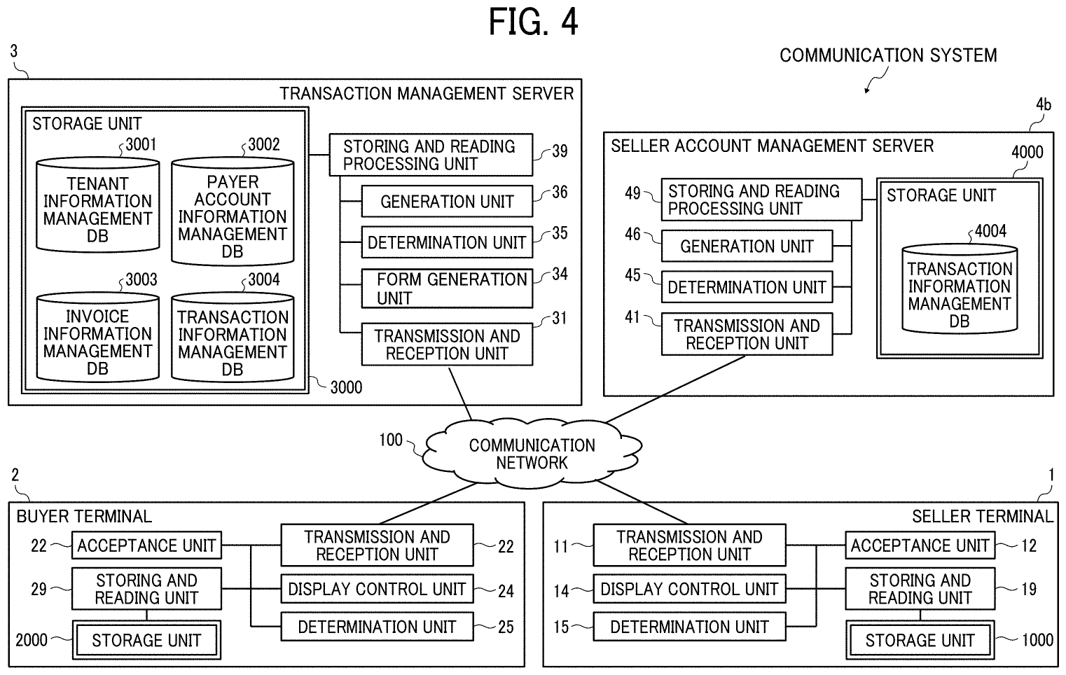

Next, referring to FIGS. 2 and 4, a functional configuration of the communication system is described according to the embodiments. FIG. 4 is a block diagram illustrating a functional configuration of the communication system of FIG. 1 according to the embodiment. The account management server 4a for the buyer illustrated in FIG. 1 has substantially the same function as that of the account management server 4b, and the description thereof is omitted.

Functional Configuration of Seller Terminal

Referring to FIGS. 2 and 4, a functional configuration of the seller terminal 1 is described according to the embodiment. As illustrated in FIG. 4, the seller terminal 1 includes a transmission and reception unit 11, an acceptance unit 12, a display control unit 14, a determination unit 15, and a storing and reading processing unit 19. These units are functions implemented by or caused to function by operating any of the hardware elements illustrated in FIG. 2 in cooperation with the instructions of the CPU 101 according to the control program expanded from the HD 104 to the RAM 103. The seller terminal 1 further includes a storage unit 1000 implemented by the RAM 103 and the HD 104 illustrated in FIG. 2.

Functional Units of Seller Terminal

Next, each functional unit of the seller terminal 1 will be described. The transmission and reception unit 11, which is implemented by instructions of the CPU 101, the external device connection I/F 108, and the network I/F 109 illustrated in FIG. 2, transmits or receives various types of data (or information) to or from other terminal, device, apparatus, or system through the communication network 100.

The acceptance unit 12, which is mainly implemented by the instructions from the CPU 101, the keyboard 111 and the pointing device 112, illustrated in FIG. 2, receives various inputs from the user.

The display control unit 14, which is mainly implemented by instructions from the CPU 101 illustrated in FIG. 2, outputs image data to the display 106 or an external display connected to the external device connection I/F 108 to cause an image be displayed. The display control unit 14 has a web browser function.

The determination unit 15, which is implemented by instructions of the CPU 101 illustrated in FIG. 2, has a function of making various determinations.

The storing and reading processing unit 19, which is mainly implemented by instructions from the CPU 101 and the HDD controller 105 illustrated in FIG. 2, performs processing of storing various types of information in the storage unit 1000 and reading various types of information stored in the storage unit 1000.

Functional Configuration of Buyer Terminal

Referring to FIGS. 3 and 4, a functional configuration of the buyer terminal 2 is described according to the embodiment. As illustrated in FIG. 4, the buyer terminal 2 includes a transmission and reception unit 21, an acceptance unit 22, a display control unit 24, a determination unit 25, and a storing and reading processing unit 29. The transmission and reception unit 21, the acceptance unit 22, the display control unit 24, the determination unit 25, and the storing and reading processing unit 29 of the buyer terminal 2 are substantially similar in function to the transmission and reception unit 11, the acceptance unit 12, the display control unit 14, the determination unit 15, and the storing and reading processing unit 19 of the seller terminal 1, and thus description thereof is omitted. Similarly, since the storage unit 2000 has the same function as that of the storage unit 1000, description thereof will be omitted.

Functional Configuration of Transaction Management Server

Next, referring to FIGS. 3 to 4, a functional configuration of the transaction management server 3 is described according to the embodiment. As illustrated in FIG. 4, the transaction management server 3 includes a transmission and reception unit 31, a form generation unit 34, a determination unit 35, a generation unit 36, and a storing and reading processing unit 39. These units are functions implemented by or caused to function by operating any of the hardware elements illustrated in FIG. 2 in cooperation with the instructions of the CPU 101 according to the control program expanded from the HD 104 to the RAM 103. The transaction management server 3 further includes a storage unit 3000 implemented by the RAM 103 and the HD 104 illustrated in FIG. 2.

Tenant Information Management Table

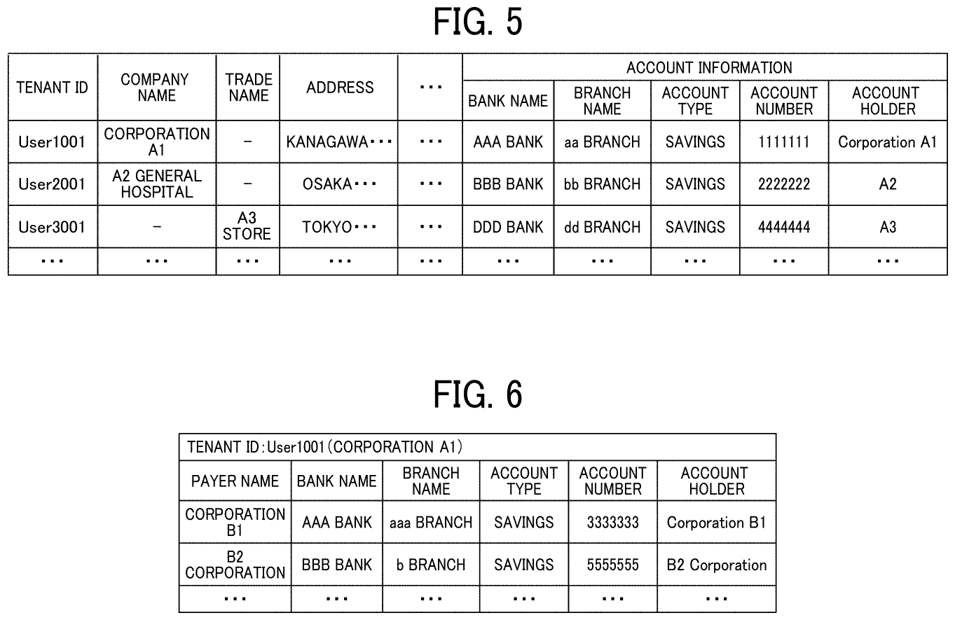

FIG. 5 is a conceptual diagram illustrating a tenant information management table. The storage unit 3000 stores a tenant information management DB 3001, such as the tenant management information table illustrated in FIG. 5. The table of FIG. 5 stores contents related to business information of the tenant. The table stores, for each tenant, a tenant ID, a tenant name (company name, trade name, etc.), a tenant address (location), and account information such as a bank account of the tenant, in association with each other. The account information includes information indicating a bank name, a branch name, an account type, an account number, and an account holder name. In the description of the embodiment, the tenant is defined as a customer unit, more specifically, a unit of users belonging to a group as a customer, such as a company or an organization, having a right to use a service with an agreement or a contract, for example. In the description of the embodiment, the tenant is defined as a customer unit, more specifically, a unit of one or more users belonging to a group as a customer, such as a company, a business unit, an organization, etc. having a right to use a service, such as the service provided by the communication system, with an agreement or a contract, for example. The service user company A is an example of tenant.

Payer Account Information Management Table

FIG. 6 is a conceptual diagram illustrating an example of payer account information management table. The storage unit 3000 stores a payer account information management DB 3002, such as the payer information management table as illustrated in FIG. 6. The table stores, for each tenant as the service user company, contents related to an account used by the payer to transfer the billing amount to the tenant. Specifically, the table stores information on an account of a payer (information indicating a payer name, a bank name, a branch name, an account type, an account number, and an account holder name) in association with each tenant ID of the tenant as a transfer destination.

Invoice Information Management Table

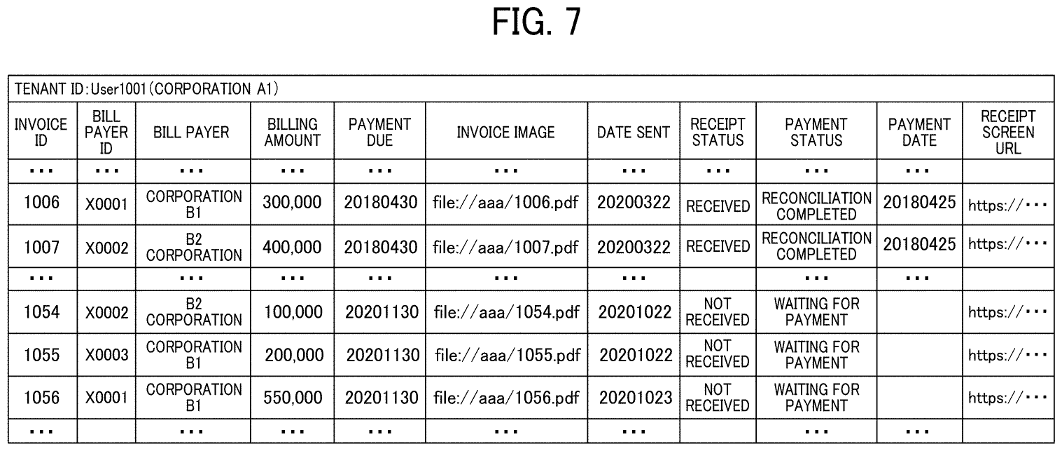

FIG. 7 is a conceptual diagram illustrating an example of invoice information management table. The storage unit 3000 stores an invoice information management DB 3003, such as the invoice information management table as illustrated in FIG. 7. The table of FIG. 7 stores contents of an invoice generated by the service providing company C on behalf of the service user company A. The table stores, for each tenant ID, an invoice ID, a bill payer ID, a bill payer name, a billing amount, a payment due date, an invoice image, a date sent, a receipt status, a payment status, and a payment date, and a URL as a storage destination of a receipt screen, in association with each other. The receipt status is information indicating whether or not an invoice issued by the seller A1 to the buyer B1 has been received by the buyer B1.

Transaction Information Management Table

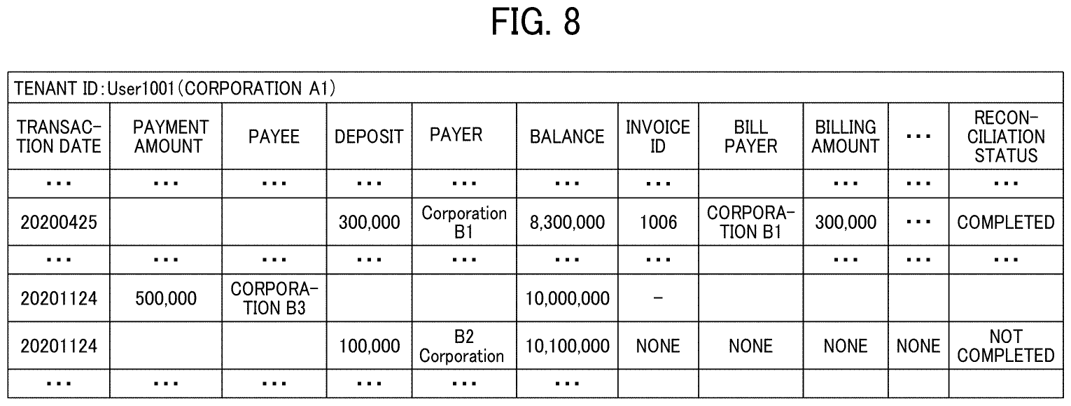

FIG. 8 is a conceptual diagram illustrating an example of transaction information management table. The storage unit 300) stores a transaction information management DB 3004, such as a transaction information management table illustrated in FIG. 8. The table stores various information regarding transactions, i.e., deposit or withdraw, of the bank account of each service user company, managed by the financial institution. The service providing company C is able to acquire transaction information in relation to the bank account of the service user company A from the financial institution D2, based on, for example, information previously registered by the service user company A, according to a contract with the service user company A. The table stores, for each tenant ID identifying a service user company, various information such as a transaction date, a payment amount, a payee, a deposit amount, a payer, a balance, an invoice ID, a bill payer, a billing amount, and a reconciliation status in association.

Functional Configuration of Transaction Management Server

Next, functional units of the transaction management server 3 are described in detail, according to the embodiment. In the following description of each functional unit of the transaction management server 3, a relationship of each functional unit with some elements illustrated in FIG. 2 is described.

The transmission and reception unit 31 of the transaction management server 3 illustrated in FIG. 4, which is implemented by instructions of the CPU 101 and the network I/F 109 illustrated in FIG. 2, transmits or receives various types of data (or information) to or from other terminal, device, apparatus, or system through the communication network 100.

The form generation unit 34, which is implemented by instructions of the CPU 101 illustrated in FIG. 2, has a function of generating specific data (information) such as a form. Details of generating the form will be described later.

The determination unit 35, which is implemented by instructions of the CPU 101 illustrated in FIG. 2, has a function of making various determinations. Details of determinations will be described later.

The generation unit 36 is implemented by instructions from the CPU 101 illustrated in FIG. 2, and generates a receipt screen or obtains a URL of the receipt screen, as described below.

The storing and reading processing unit 39, which is implemented by instructions from the CPU 101 and the HDD controller 105 illustrated in FIG. 2, performs processing of storing various types of information in the storage unit 3000 and reading various types of information stored in the storage unit 3000.

Functional Configuration of Account Management Server

Next, referring to FIGS. 3 to 4, a functional configuration of the account management server 4b for the seller is described according to the embodiment. As illustrated in FIG. 4, the account management server 4b includes a transmission and reception unit 41, a determination unit 45, a generation unit 46, and a storing and reading processing unit 49. These units are functions implemented by or caused to function by operating any of the hardware elements illustrated in FIG. 2 in cooperation with the instructions of the CPU 101 according to the control program expanded from the HD 104 to the RAM 103. The account management server 4b further includes a storage unit 4000 implemented by the RAM 103 and the HD 104 illustrated in FIG. 2.

Transaction Information Management Table

FIG. 8 is a conceptual diagram illustrating an example of transaction information management table. The storage unit 4000 stores a transaction information management DB 4004, such as a transaction information management table illustrated in FIG. 8. The table stores various information regarding transactions, i.e., deposit or withdraw, of each bank account of all customers of the service user company (that is, seller), managed by the financial institution. Since the transaction information management DB 4004 has a data structure that is the same as that of the above-described transaction information management DB 3004, description thereof is omitted. That is, the transaction information management DB 4004 and the transaction information management DB 3004 are kept the same in contents for the same tenant.

Functional Configurations of Account Management Server

Next, functional units of the account management server 4b are described in detail, according to the embodiment. In the following description of each functional unit of the account management server 4b, a relationship of each functional unit with some elements illustrated in FIG. 2 is described.

The transmission and reception unit 41 of the account management server 4b illustrated in FIG. 4, which is implemented by instructions of the CPU 101 and the network I/F 109 illustrated in FIG. 2, transmits or receives various types of data (or information) to or from other terminal, device, apparatus, or system through the communication network 100.

The determination unit 45, which is implemented by instructions of the CPU 101 illustrated in FIG. 2, has a function of making various determinations. Details of determinations will be described later.

The generation unit 46 is implemented by instructions from the CPU 101 illustrated in FIG. 2, and generates various screens, as described below.

The storing and reading processing unit 49, which is implemented by instructions from the CPU 101 and the HDD controller 105 illustrated in FIG. 2, performs processing of storing various types of information in the storage unit 4000 and reading various types of information stored in the storage unit 4000.

Processes and Operations

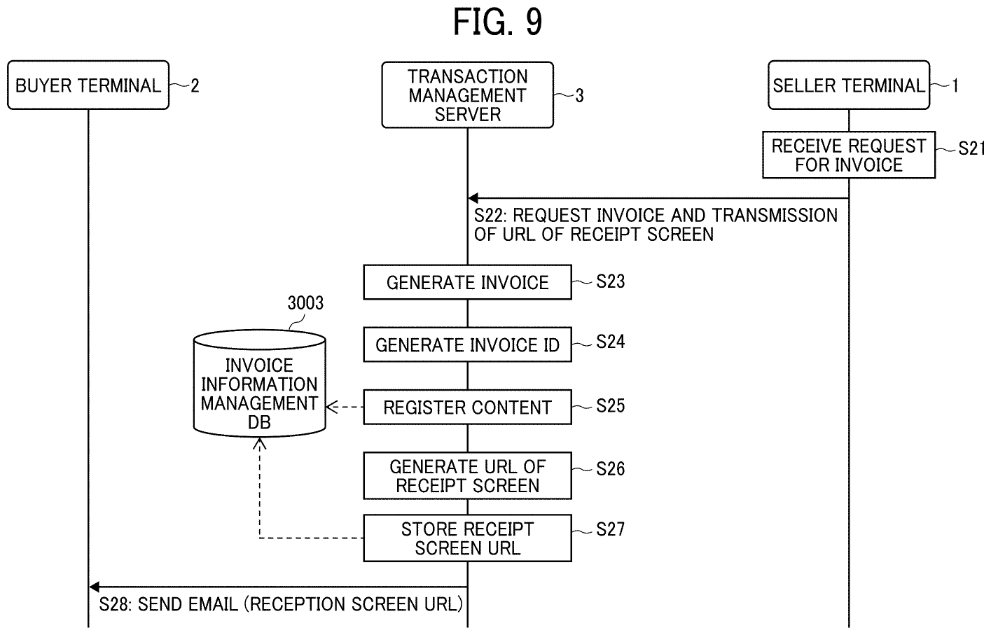

Next, referring to FIGS. 9 to 25, processing, performed by the communication system illustrating in FIG. 1, is described according to the embodiment.

Processing to Send Invoice

Referring to FIG. 9, processing of sending invoice is described according to the embodiment. FIG. 9 is a sequence diagram illustrating processing to sending invoice according to the embodiment.

At the seller terminal 1, the seller A1 operates the seller terminal 1 to enter details of billing from which the invoice is created, and the acceptance unit 12 receives a request for generating the invoice (S21). Then, the transmission and reception unit 11 transmits, to the transaction management server 3, a request for generating the invoice and transmission of the receipt screen (S22). This request includes information indicating details of billing received at S21. Accordingly, the transmission and reception unit 31 of the transaction management server 3 receives the request transmitted at S22.

Next, at the transaction management server 3, the form generation unit 34 generates an invoice based on the information indicating details of billing received at S22 (S23). For example, the information indicating details of billing includes a bill payer, a billing amount, a payee, a payment due, etc.

Further, the form generation unit 34 generates an invoice ID of the invoice generated at S23 (S24). Then, the form generation unit 34 adds the generated invoice ID to the invoice. The form generation unit 34 may generate an invoice after generating the invoice ID.

Next, at the transaction management server 3, the storing and reading processing unit 39 registers the information indicating contents of the invoice generated at S23 and the invoice ID generated at S24, in the invoice information management DB3003 (S25).

Next, at the transaction management server 3, the generation unit 36 generates a receipt screen URL, which is a URL of a receipt screen for receiving the invoice generated at S23 (S26). The storing and reading processing unit 39 registers the receipt screen URL generated at S26 in the invoice information management DB3003 in association with the above-described information on the invoice (S27).

The transmission and reception unit 31 of the transaction management server 3 transmits an email including the receipt screen URL generated at S26 to the buyer terminal 2. In this example, the transmission and reception unit 31 may not transmit the email including the receipt screen URL directly to the buyer terminal 2. For example, the transmission and reception unit 31 may transmit the email to a preset mail address of the buyer, and the buyer terminal 2 may receive the email from a mail server. Further a way of transmitting the receipt screen URL is not limited to email transmission. For example, the message including the receipt screen URL may be transmitted to the buyer terminal 2 via the messenger application, in another example, the generation unit 36 may generate a two-dimensional code indicating the receipt screen URL, and embed the two-dimensional code in the invoice image. The transmission and reception unit 31 may transmit the invoice image in which the two-dimensional code is embedded to a printer to cause the printer to print out the invoice image on recording paper. The printed invoice can be then sent to the buyer by mail.

Processing to Display Receipt Screen

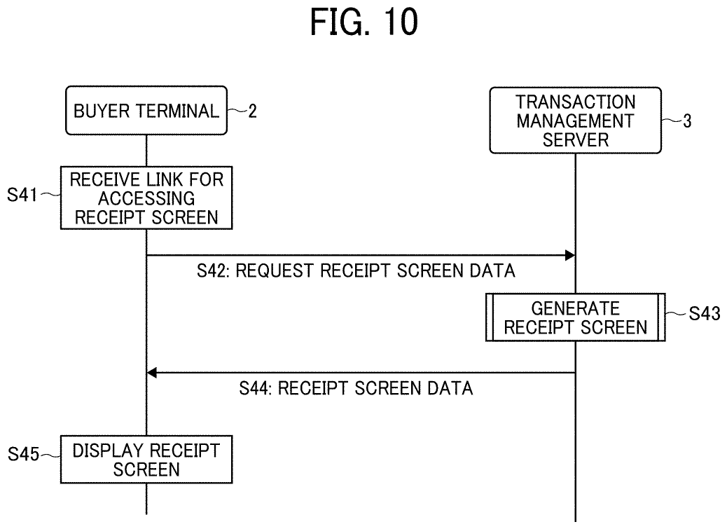

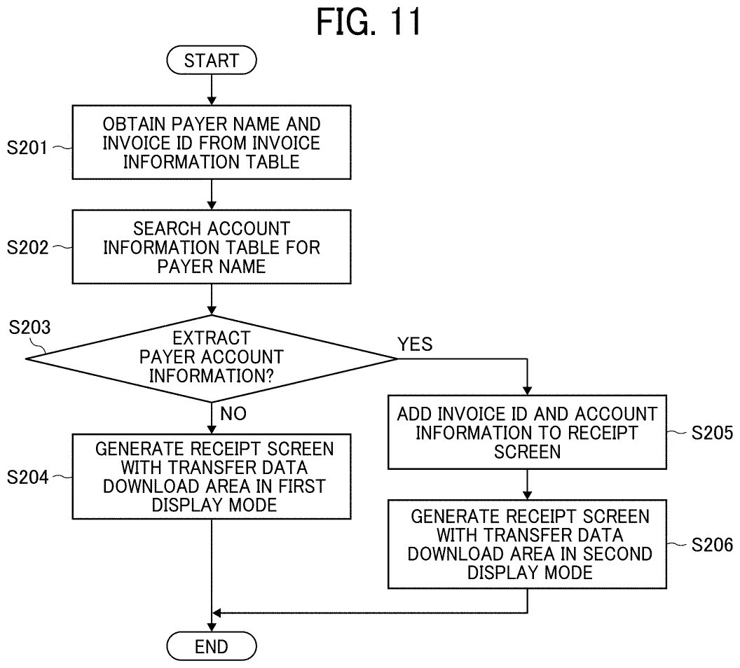

Referring next to FIGS. 10 to 13, processing of displaying the receipt screen is described according to the embodiment. FIG. 10 is a sequence diagram illustrating processing of displaying the receipt screen according to the embodiment. FIG. 11 is a flowchart illustrating processing of generating the receipt screen according to the embodiment.

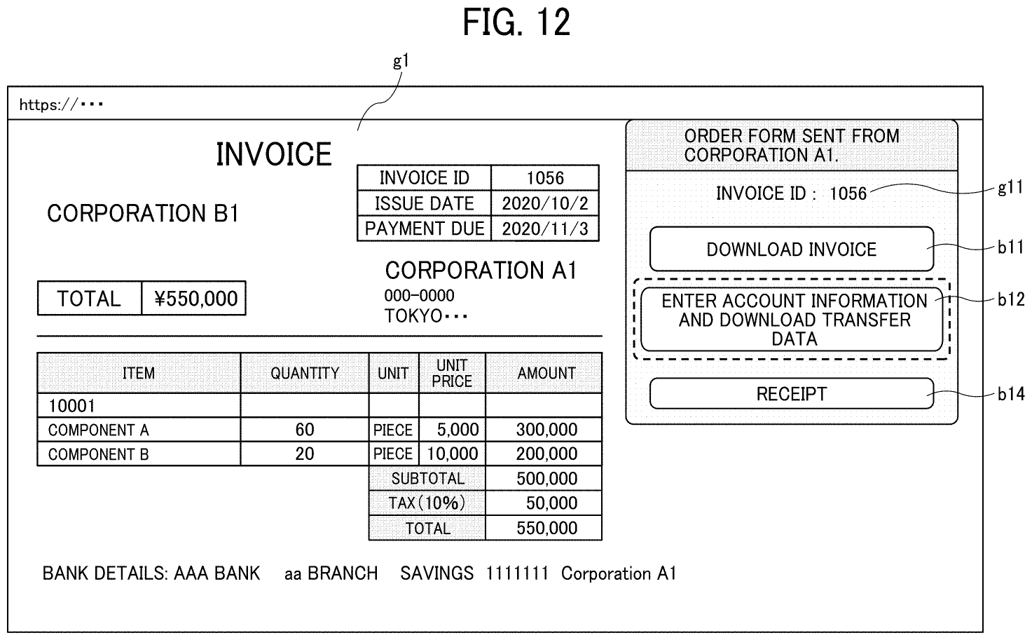

First, at the buyer terminal 2, in response to the buyer B1 operating the buyer terminal 2 to select a link to the receipt screen illustrated in FIG. 12, the acceptance unit 22 receives a request for accessing the link (S41). Specifically, the acceptance unit 22 receives operation of clicking the receipt screen URL included in the email transmitted from the transaction management server 3 to the buyer terminal 2 at 528.

In response to the acceptance unit 22 receiving operation to open the link of the receipt screen (S41), the transmission and reception unit 21 of the buyer terminal 2 transmits a request for screen data of the receipt screen to the transaction management server 3 (S42).

Next, at the transaction management server 3, the generation unit 36 generates a receipt screen in response to the request for the receipt screen (S43). Referring to FIG. 11, the processing of generating the receipt screen is described in detail.

Processing to Generate Receipt Screen

As illustrated in FIG. 11, the storing and reading processing unit 39 searches the invoice information management DB3003 (see FIG. 7) using the URL of the requested receipt screen as a search key, to read the corresponding bill payer name and invoice ID (S201). Next, the storing and reading processing unit 39 searches the payer account information management DB3002 (see FIG. 6) using the read bill payer name as a search key, to read the payer account information corresponding to a payer name that matches the bill payer name (S202).

When the payer account information has not been read (S203: NO), that is, when the account information of the buyer B1 has not been registered as the payer account information, the generation unit 36 generates data of a receipt screen, such that a transfer data download area (to be described later) is displayed in a first display mode (S204). On the other hand, when the payer account information has been read (S203: YES), that is, when the account information of the buyer B1 has already been registered as the payer account information, the generation unit 36 generates data of a receipt screen including the payer account information and the invoice ID read out at S201 (S205), such that the transfer data download area is displayed in a second display mode (S206). The processing of generating the receipt screen then ends.

Subsequently, the transmission and reception unit 31 of the transaction management server 3 transmits the screen data of the receipt screen, generated, to the buyer terminal 2 (544).

At the buyer terminal 2, the display control unit 24 causes the display 106 to display a receipt screen based on the screen data of the receipt screen.

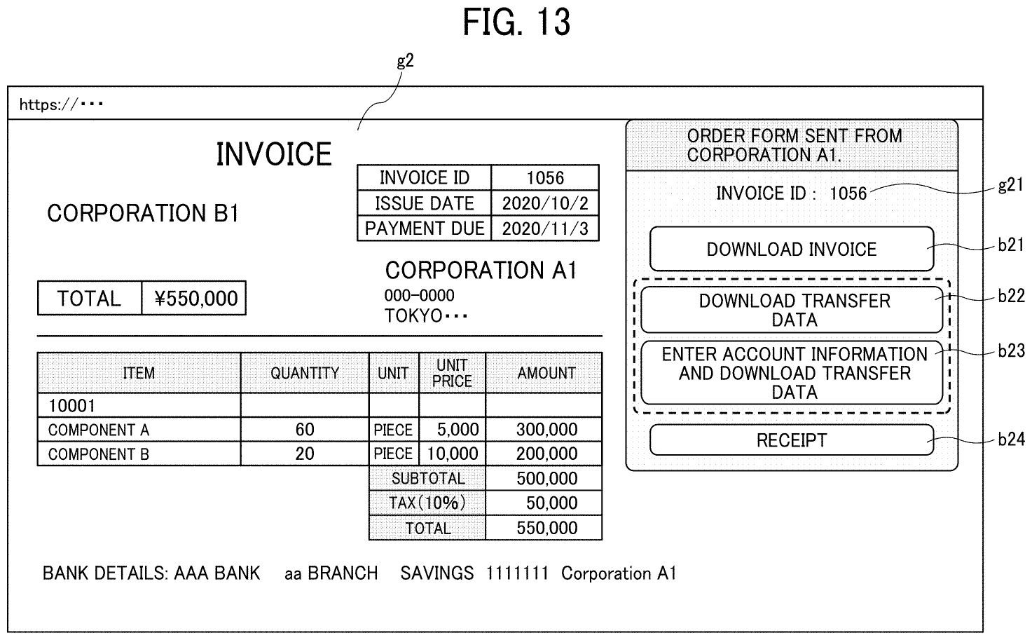

FIGS. 12 and 13 are diagrams each illustrating an example of a receipt screen displayed on the buyer terminal 2.

Receipt Screen

Referring to FIGS. 12 and 13, an example of receipt screen displayed on the buyer terminal 2 is described according to the embodiment. FIG. 12 is a diagram illustrating an example of a receipt screen displayed on the buyer terminal when the payer account information is not registered. As illustrated in FIG. 12, the receipt screen includes an invoice preview display field g1, an invoice ID display field g11, an invoice download button b11, a transfer data download button b12, and a receipt button b14.

Among them, the invoice preview display field g1 displays therein a preview of the invoice image. The preview invoice image may be an image obtained by reducing a size of the original invoice image or may be an image of the invoice having the original image size. When the invoice includes a plurality of pages, an image of the first page may be displayed as a preview image. The invoice ID display field g11 displays therein an invoice ID.

The invoice download button b11 is a button for allowing the buyer B1 to download the invoice image to the buyer terminal 2. The transfer data download button b12 is a button for allowing the buyer B1 to enter payer account information and download transfer data including the invoice ID of the invoice to the buyer terminal 2. The receipt button b14 is a button for allowing the buyer B1 to notify the seller that the invoice has been received.

FIG. 13 is a diagram illustrating an example of a receipt screen displayed on the buyer terminal when the payer account information is registered. As illustrated in FIG. 13, the receipt screen includes a invoice preview display field g2, an invoice ID display field g21, an invoice download button b21, a first transfer data download button b22, a second transfer data download button b23, and a receipt button b24. The invoice preview display field g2, the invoice ID display field g21, the invoice download button b21, and the receipt button b24 are the same as the invoice preview display field g1, the invoice ID display field g11, the invoice download button b11, and the receipt button b14 illustrated in FIG. 12, respectively, and description thereof is omitted.

The first transfer data download button b22 is a button for downloading transfer data including an invoice ID of the invoice to the buyer terminal 2 without changing the registered payer account information. The second transfer data download button b23 is a button for downloading transfer data including an invoice ID of the invoice to the buyer terminal 2 after changing the registered payer account information.

That is, depending on whether or not the account information of the buyer B1 has been registered as the payer account information, display of screen is switched between the receipt screen with the transfer data download button b12 (FIG. 12), and the receipt screen with the first transfer data download button b22 and the second transfer data download button b23 (FIG. 13).

Processing to Acquire Invoice Image

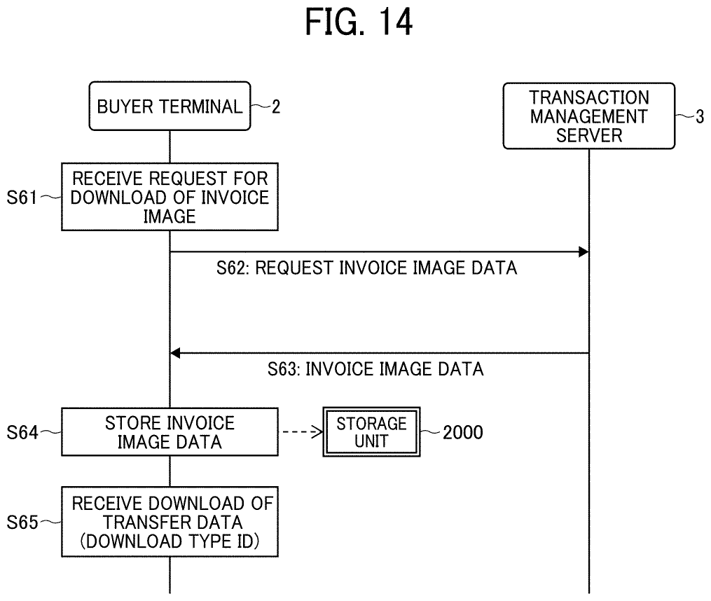

Next, referring to FIG. 14, processing of acquiring an invoice image is described according to the embodiment. FIG. 14 is a sequence diagram illustrating processing of acquiring an invoice image according to the embodiment.

First, at the buyer terminal 2, in response to the acceptance unit 22 receiving operation of clicking the invoice download button b11 or b21 displayed on the receipt screen (S61), the transmission and reception unit 21 transmits a request for the invoice image and the invoice ID of a particular invoice to the transaction management server 3 (S62).

Next, at the transaction management server 3, the storing and reading processing unit 39 searches the invoice information management DB3003 using the transmitted invoice ID as a search key, to read the storage destination of the invoice image and acquire the invoice image from the read storage destination. Then, the transmission and reception unit 21 of the transaction management server 3 transmits the acquired invoice image to the buyer terminal 2 (S63).

Next, at the buyer terminal 2, the storing and reading processing unit 29 stores the invoice image in a predetermined storage destination of the storage unit 200 ((64). The predetermined storage destination may be a default storage destination or may be a storage destination designated by the buyer B1.

At the buyer terminal 2, the acceptance unit 22 receives an operation of clicking the transfer data download button b12 displayed on the receipt screen of FIG. 12, or one of the first transfer data download button b22 and the second transfer data download button b23 displayed on the receipt screen of FIG. 13 (S65). In a case that operation of clicking the transfer data download button b12 displayed on the receipt screen of FIG. 12 is received, the acceptance unit 22 selects “T1” as a download type ID. In a case that the operation of clicking the first transfer data download button b22 displayed on the receipt screen illustrated in FIG. 13 is received, the acceptance unit 22 selects “T2” as the download type ID. Further, In a case that operation of clicking the second transfer data download button b23 displayed on the receipt screen of FIG. 13 is received, the acceptance unit 22 selects “T3” as the download type ID.

Processing to Download Transfer Data

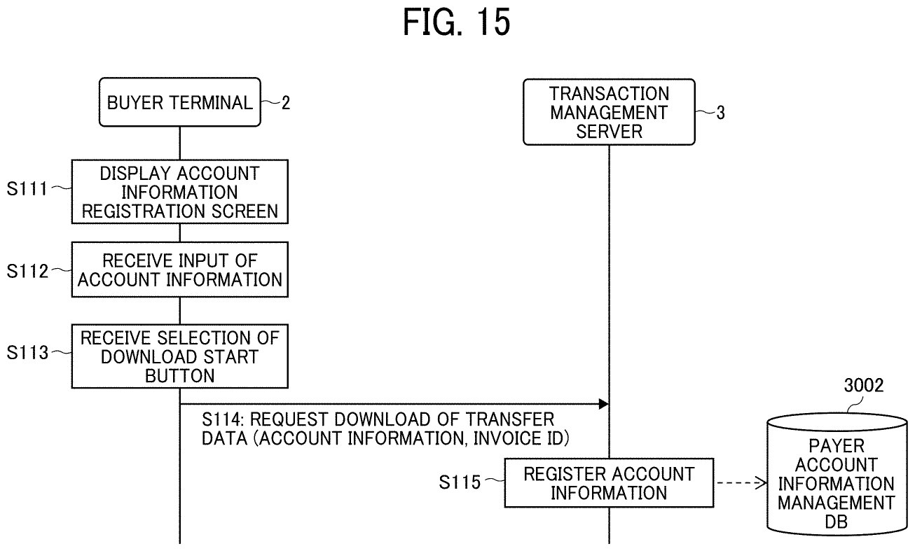

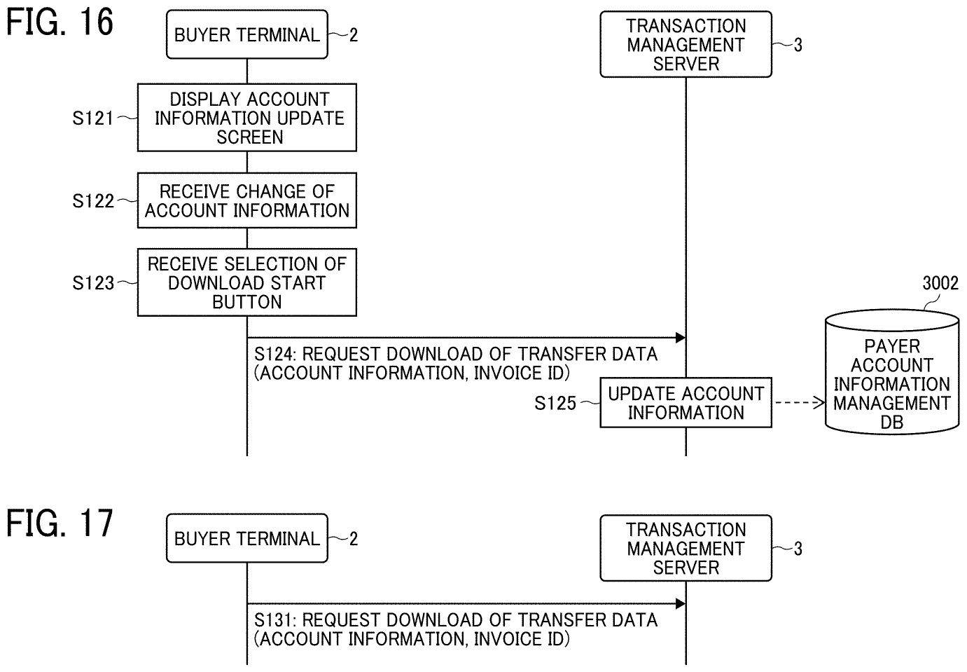

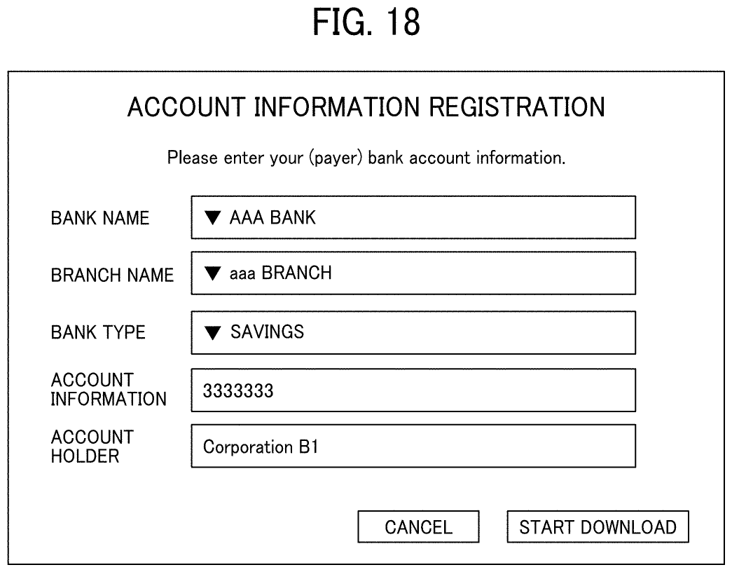

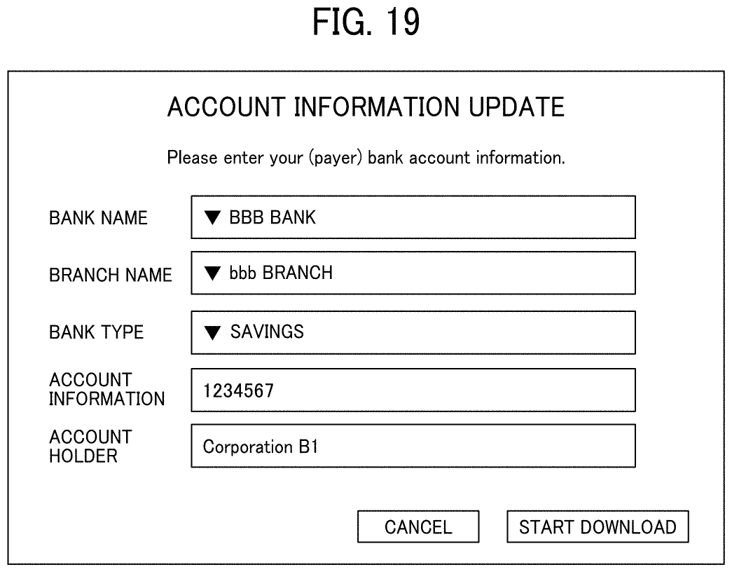

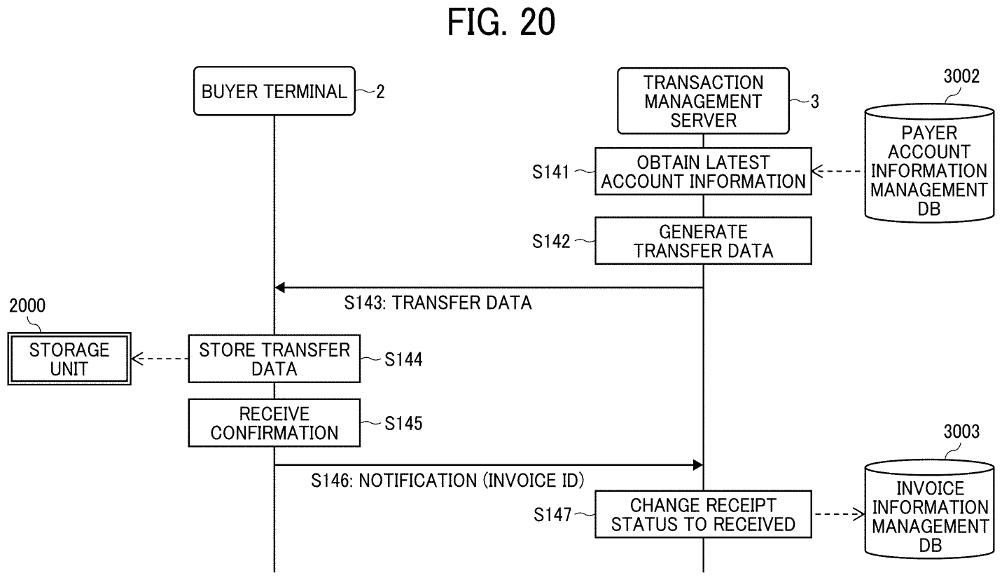

Next, referring to FIGS. 15 to 21, processing to download transfer data is described according to the embodiment. FIG. 15 is a sequence diagram illustrating example operation to process a request for downloading transfer data when the download type ID is T1. FIG. 16 is a sequence diagram illustrating example operation to process a request for downloading transfer data when the download type ID is T3. FIG. 17 is a sequence diagram illustrating example operation to process a request for downloading transfer data when the download type ID is T2. FIG. 18 is a diagram illustrating an example account information registration screen displayed on the buyer terminal. FIG. 19 is a diagram illustrating an example account information update screen displayed on the buyer terminal. FIG. 20 is a sequence diagram illustrating example processing of downloading transfer data. FIG. 21 is a diagram illustrating an example of transfer data.

When T1 is selected as the download type ID, first, as illustrated in FIG. 15, at the buyer terminal 2, the display control unit 24 controls the display 106 to display an account information registration screen (S111). FIG. 18 is a diagram illustrating an example account information registration screen displayed on the buyer terminal 2. The account information registration screen displays items of account information such as a bank name, a branch name, an account type, an account number, and an account holder name, a download start button, and a cancel button. In this example, the initial value of each item is set to “blank”. The account information registration screen may be displayed by switching from the receipt screen, or may be displayed as a pop-up screen of the receipt screen.

Next, the acceptance unit 22 receives operation of entering a value of each item on the account information registration screen (S112). Specifically, the acceptance unit 22 receives operation of the buyer B1 selecting a value of each item, such as the bank name, the branch name, and the account type, from a pull-down list, and operation of the buyer B1 entering a value of each item, such as the account number and the account name, to a corresponding text box. FIG. 18 illustrates a state in which the value of each item has been selected or entered. Next, the acceptance unit 22 receives operation of clicking the download button on the account information registration screen (S113). When the acceptance unit 22 receives the operation of clicking the cancel button on the account information registration screen, the display control unit 24 displays a receipt screen.

Next, in response to the acceptance unit 22 receiving the operation of clicking the download button on the account information registration screen, the transmission and reception unit 21 of the buyer terminal 2 transmits a transfer data download request, account information entered via the account information registration screen, and an invoice ID, to the transaction management server 3 (S114). The storing and reading processing unit 39 of the transaction management server 3 stores the account information, received, in the payer account information management DB3002 (S115). Thus, when the account information of the buyer B1 is not registered as the payer account information, the account information can be registered via the account information registration screen.

When T3 is selected as the download type ID, first, as illustrated in FIG. 16, at the buyer terminal 2, the display control unit 24 controls the display 106 to display an account information update screen (S121). The account information update screen is the same as the account information registration screen of FIG. 18 except for a title of the screen. Further, the account information update screen displays therein account information of the buyer B1, which is the registered payer account information, as an initial value of each item.

Next, the acceptance unit 22 receives operation of changing a value of each item on the account information update screen (S122). Specifically, the acceptance unit 22 receives operation of the buyer B1 changing values of one or more items such as the bank name, branch name, and account type using the pull-down list, and operation of the buyer B1 changing values of one or more items such as the account number and the account name initially displayed in the text boxes. FIG. 19 is a diagram illustrating an example of an account information update screen displayed on the buyer terminal 2 after the acceptance unit 22 receives the operation of changing values of items.

Next, the acceptance unit 22 receives operation of clicking the download button on the account information update screen (S123). Next, in response to the acceptance unit 22 receiving the operation of clicking the download button on the account information update screen, the transmission and reception unit 21 of the buyer terminal 2 transmits a transfer data download request, updated account information entered via the account information update screen, and an invoice ID, to the transaction management server 3 (S124). The storing and reading processing unit 39 of the transaction management server 3 stores the account information, received, in the payer account information management DB3002 (S125). Thus, in a case that the account information of the buyer B1 has been registered as the payer account information, the account information can be changed via the account information update screen.

When T2 is selected as the download type ID, as illustrated in FIG. 17, at the buyer terminal 2, in response to the acceptance unit 22 receiving operation of clicking the first transfer data download button b22 displayed on the receipt screen, the transmission and reception unit 21 transmits a transfer data download request, account information, and an invoice ID to the transaction management server 3 (S131). In this case, the account information of the buyer B, which is registered as the payer account information, is not changed.

Subsequently, after processing of FIG. 15, 16, or 17, as illustrated in FIG. 20, at the transaction management server 3, the storing and reading processing unit 39 searches the payer account information management DB 3002 using the payer name included in the account information transmitted at S114, S124, or S131, as a search key, to acquire the latest payer account information corresponding to the payer name (S141). Alternatively, the account information transmitted at S114, S124, or S131 may be acquired as the latest account information.

Next, the form generation unit 34 generates transfer data based on the invoice ID transmitted at S114, S124, or S131, and the account information of the payer acquired at S141 (S142). Specifically, the storing and reading processing unit 39 searches the invoice information management DB3003 using the invoice ID as a search key, to acquire invoice information such as a tenant ID, a billing amount, and a payment due date each corresponding to the invoice ID. Further, the storing and reading processing unit 39 searches the tenant information management DB3001 using the acquired tenant ID as a search key, to acquire account information corresponding to the tenant ID as account information of the payee. Then, the form generation unit 34 generates transfer data that contains an invoice ID, account information of a payer, account information of a payee, a billing amount as a transfer amount, and a payment due date as a transfer date, according to a predetermined format.

In another example, the transfer data may contain a billing amount, which is changed by the buyer B1 via a predetermined screen, as a transfer amount. In yet another example, the transfer data may contain, as a transfer date, a date calculated based on a predetermined rule of a payment due date, for example, a date 10 days before or the last date of the last month. Further, the transfer data may contain, as a transfer date, a date entered by the buyer B1 via a predetermined screen. The information contained in the transfer data may include one or more items of information, from among various items of invoice information such as a bill payer name or a date sent, information related to return of a product or service corresponding to the invoice information, and information indicating an amount of money paid by the buyer B1 in the past transaction with the seller A1 and to be offset by this transfer based on the transfer data. The amount of offset is an example of a modification to the amount indicated by the invoice (that is, the amount of item indicated by the form).

FIG. 21 is a diagram illustrating an example of transfer data. As illustrated in FIG. 21, the transfer data includes information on transfer such as account information of the payer, account information of the payee, a transfer amount, a transfer date, etc., and the invoice ID. The transfer data illustrated in FIG. 21 is described in an Extensible Markup Language (XML) format, but the transfer data may be written in any format. The transfer data may be described in a JavaScript Object Notation (jSON) format, a Comma-Separated Values (CSV) format, or a text format.

Next, the transmission and reception unit 31 of the transaction management server 3 transmits the generated transfer data to the buyer terminal 2 (S143).

Next, at the buyer terminal 2, the storing and reading processing unit 29 stores the transfer data in a predetermined storage destination of the storage unit 2000 (S144). The predetermined storage destination may be a default storage destination or may be a storage destination designated by the buyer B1. In response to the acceptance unit 22 receiving operation of clicking the receipt button b14 displayed on the receipt screen (S145), the transmission and reception unit 21 transmits a notification indicating receipt and an invoice ID to the transaction management server 3 (S146).

The storing and reading processing unit 39 of the transaction management server 3 searches the invoice information management DB3003 using the invoice ID as a search key to identify the invoice information corresponding to the invoice ID, and changes the receipt status of the identified invoice information from “not received” to “received” (S147).

The service providing company C is able to generate the invoice and the transfer data including the invoice ID of the invoice, and send the invoice and the transfer data to the business partner company B.

Subsequently, the buyer B1 instructs to transfer using the downloaded transfer data according to a predetermined procedure. For example, the buyer B1 instructs to transfer by uploading transfer data via a predetermined screen provided by the financial institution D1 that manages the account of the buyer B1, using such as firm banking or Internet banking. Then, the financial institution D1 that manages the account of the buyer B1 transfers the amount of money according to the transfer data, to the financial institution D2 that manages the account of the seller A1. At this time, information such as the invoice ID included in the transfer data is also transmitted to the financial institution D2. Thus, the seller A1 can acquire transfer record information including such as the invoice ID from the financial institution D2.

The transfer, i.e., transfer based on the transfer data does not have to be carried out via a financial institution. For example, the transfer may be made via a service such as an online payment service. In such case, for example, the service providing company C sends a two-dimensional code indicating transfer data to the buyer B1. The buyer B1 can transfer by reading the two-dimensional code via an application of a service such as an online payment service installed on the buyer terminal 2.

Processing to Reconcile Transactions

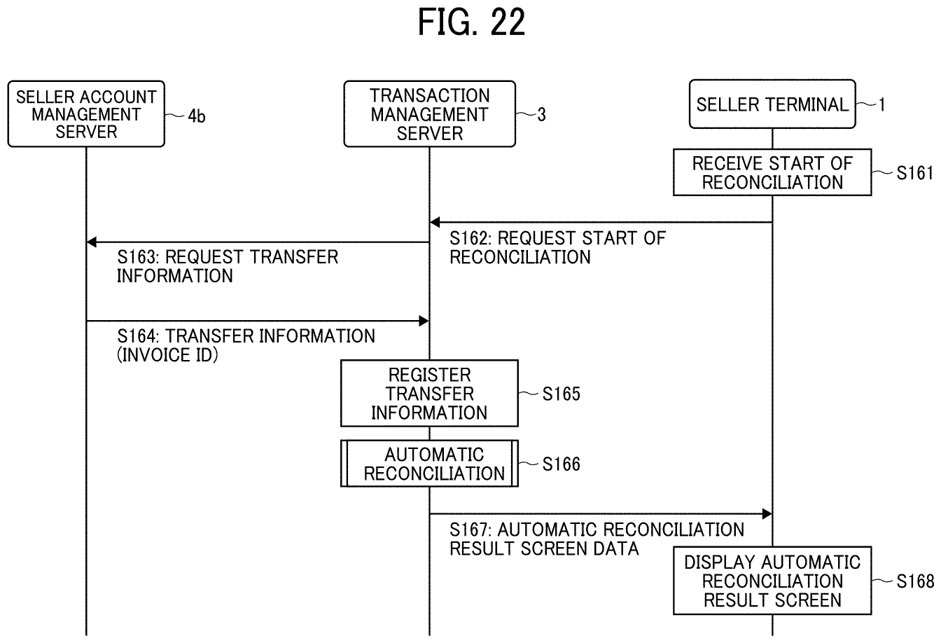

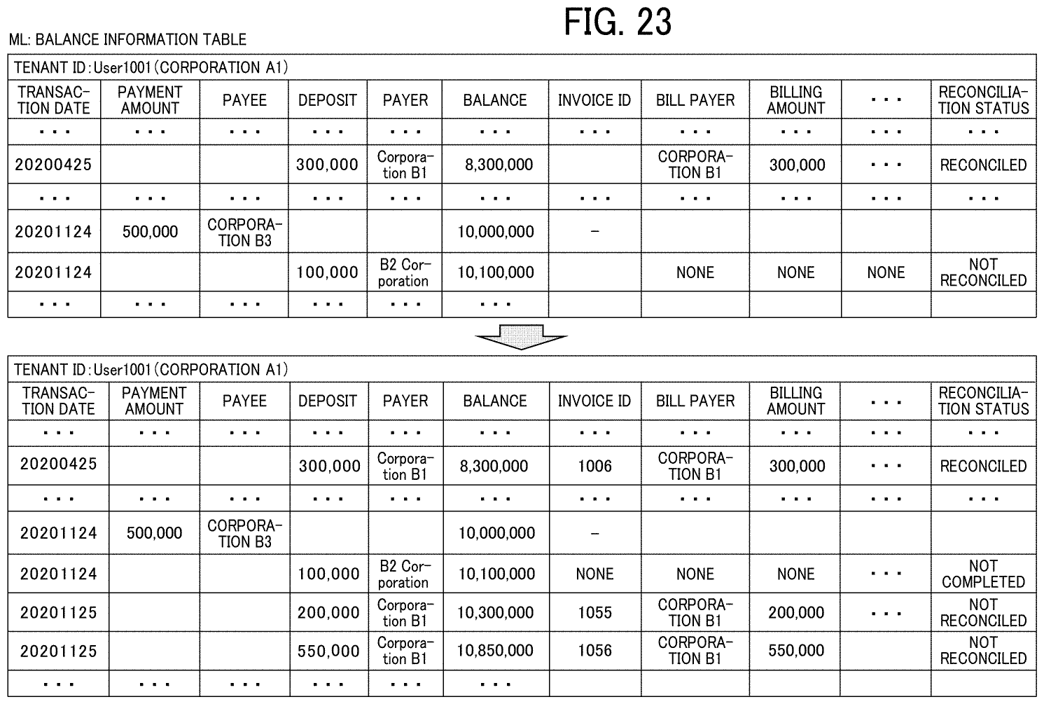

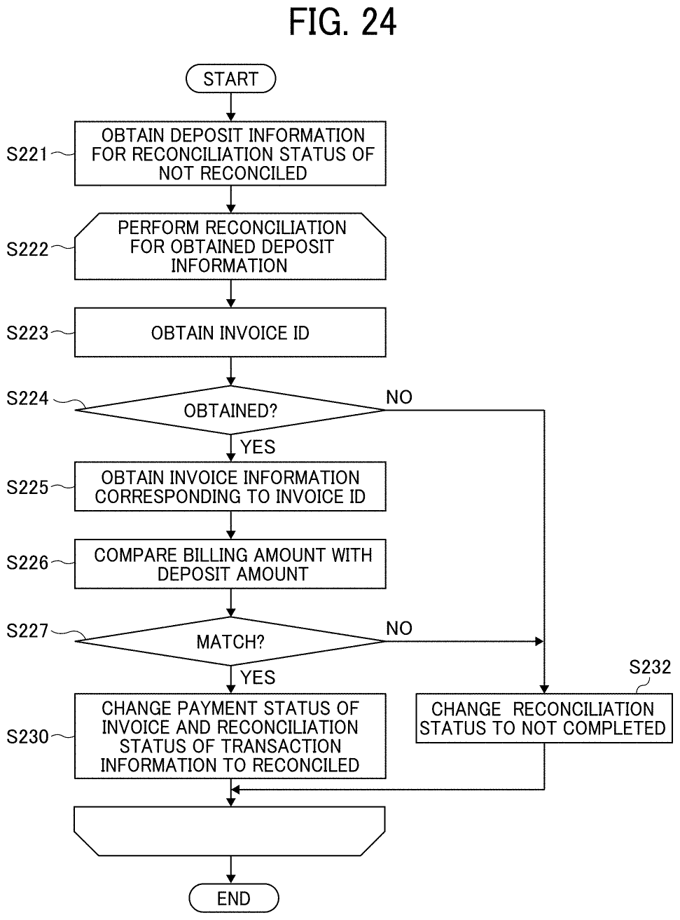

Next, referring to FIGS. 22 to 25, processing of reconciling transactions is described according to the embodiment. FIG. 22 is a sequence diagram illustrating processing of reconciling transactions according to the embodiment. FIG. 23 is a transition diagram of the transaction information management table. FIG. 24 is a flowchart illustrating automatic reconciliation process. FIG. 2S is a diagram illustrating an automatic reconciliation result screen displayed on the seller terminal.

First, as illustrated in FIG. 22, at the seller terminal 1, the acceptance unit 12 receives an input of a tenant ID and a password of the seller A1, performs a predetermined user authentication process, and then receives operation of instructing start of reconciliation. Specifically, the acceptance unit 12 receives operation of the seller A1 clicking a start button displayed on a predetermined screen (S161). Then, the transmission and reception unit 11 transmits a request for starting reconciliation to the transaction management server 3 (S162).

Next, the transmission and reception unit 31 of the transaction management server 3 transmits the request for transfer record information and the tenant ID to the account management server 4b for the seller, which manages the account of the seller A1 (S163). The transmission and reception unit 41 of the account management server 4b for the seller transmits transfer record information on the account of the seller A1, acquired based on the tenant ID, to the transaction management server 3 (S164). The transfer record information includes an invoice ID for each invoice. Here, the account management server 4b for the seller may be a server provided by the financial institution that manages the account of the seller A1, or may be a server provided by a predetermined service that cooperates with a financial institution system.

Further, the account management server 4b for the seller performs predetermined authentication processing when transmitting transfer record information on the account of the seller A1 to the transaction management server 3. For example, the seller A1 registers, via the seller terminal 1, authentication information of the account of the seller A1 in the transaction management server 3. The transmission and reception unit 31 of the transaction management server 3 transmits the authentication information identified based on the tenant ID to the account management server 4b for the seller with a request for transfer record information. Then, at the account management server 4b for the seller, the storing and reading processing unit 49 performs authentication processing based on the transmitted authentication information. The storing and reading processing unit 49 further reads transfer record information corresponding to the authentication information among the transfer record information registered in the transaction information management DB 4004. The transmission and reception unit 41 transmits the read transfer record information to the transaction management server 3.

Next, at the transaction management server 3, the storing and reading processing unit 39 registers the transmitted transfer record information in the transaction information management DB 3004 in association with the tenant ID (S165). Here, the invoice ID included in the transfer record information is also registered in the transaction information management DB 3004. FIG. 23 is a diagram illustrating a difference in contents of the transaction information management DB 3004, between the time before and the time after the transmitted transfer record information is registered. As illustrated in FIG. 23, the transmitted transfer record information (transfer information indicating transfer of deposit amounts 200,000 and 550,000 by the payer “Corporation B1”) is added to the transaction information management DB 3004, in association with the tenant ID. The “not reconciled” is registered as an initial value of the reconciliation status of the added transfer record information.

Next, the transaction management server 3 performs automatic reconciliation processing based on the invoice information and the transfer record information (S166). FIG. 24 is a flowchart illustrating details of the automatic reconciliation process.

As illustrated in FIG. 24, first, the storing and reading processing unit 39 acquires one or more records of the seller A1 having the reconciliation status of “not reconciled”, from the transaction information management DB 3004 (S221). Specifically, from among the transaction information of the seller A1 specified based on the tenant ID of the seller A1, a record of the transaction information having the reconciliation status of “not reconciled” is acquired. Here, the storing and reading processing unit 39 acquires the transaction information having “blank” values both for the deposit amount and the payee, as the record to be considered.

Next, the transaction management server 3 performs processing to reconcile transactions for each record that is obtained (S222). Specifically, the determination unit 35 acquires the invoice ID included in the record of the transaction information (S223). The determination unit 35 determines whether the invoice ID is acquired from the transaction information (S224). When the invoice ID is acquired (S224: YES), the storing and reading processing unit 39 searches the invoice information management DB 3003 using the acquired invoice ID as a search key to acquire invoice information corresponding to the invoice ID (S225). On the other hand, when the invoice ID is not acquired (S224: NO), the storing and reading processing unit 39 changes the reconciliation status of the transaction information from “not reconciled” to “not completed” (S229).

Next, the determination unit 35 compares the billing amount included in the invoice information with the deposit amount (transfer amount) included in the transaction (transfer) information (S226). When the billing amount matches the deposit amount (S227: YES), the storing and reading processing unit 39 changes the payment status of the invoice information in the invoice information management DB 3003 from “waiting for payment” to “reconciled”, and changes the reconciliation status of the transaction (transfer) information in the transaction information management DB 3004 from “not reconciled” to “reconciled” (S230). On the other hand, when the billing amount and the deposit amount do not match (S227: NO), the storing and reading processing unit 39 changes the reconciliation status of the transaction (transfer) information from “not reconciled” to “not completed” (S232).

In this way, reconciliation processing is performed on each record of transaction (deposit) information that is acquired, resulting in completion of reconciliation processing for all deposits (transfers) being made.

Next, at the transaction management server 3, the generation unit 36 generates data of automatic reconciliation result screen indicating a processing result of automatic reconciliation, based on the invoice information and the transaction (transfer) information on which the automatic reconciliation processing of S166 has been performed. The transmission and reception unit 31 transmits data of the automatic reconciliation result screen, generated, to the seller terminal 1 (S167). The display control unit 14 of the seller terminal 1 displays the automatic reconciliation result screen on the display 106 based on the transmitted screen data (S168).

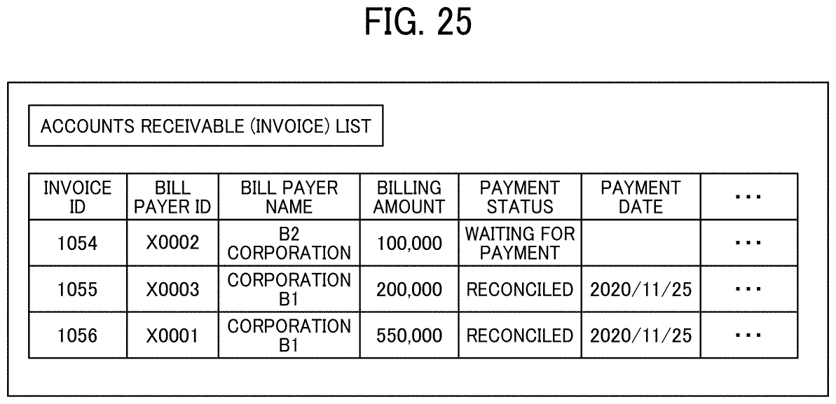

FIG. 25 is a diagram illustrating an example of the automatic reconciliation result screen displayed on the seller terminal 1. As illustrated in FIG. 25, the automatic reconciliation result screen includes items such as an invoice ID, a bill payer ID, a bill payer name, a billing amount, a payment status, and a payment date. For example, the screen of FIG. 25 indicates that the payment status of the invoice having the invoice ID of 1054 is “waiting for payment”. Further, the screen of FIG. 25 indicates that the payment statuses of the invoices having the invoice IDs of 1055 and 1056 are both “reconciled”.

In this way, the seller A1 can confirm that the accounts receivable are settled for each invoice, via the automatic reconciliation result screen.

First Variation: Transfer Reflecting Offset Amount

For various reasons, in some transactions, an amount of money different from the billing amount indicated by the issued invoice may be transferred. For example, in a case where some of delivered products are returned due to defect, the amount of money for the returned products may be offset from the billing amount. The billing amount, from which the money for the returned products is subtracted, is then transferred. In some cases, if the biller agrees to bear the transfer fee, the transfer fee may be offset from the billing amount, resulting in the transfer amount less than the billing amount by the transfer fee and the payable amount of returned products. The following describes the modified example in which transfer is made while reflecting offset amount.

Processing to Generate Receipt Screen

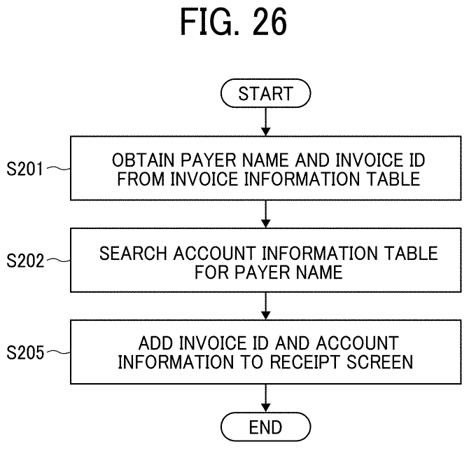

FIG. 26 is a flowchart illustrating processing of generating a receipt screen according to the modified example. Compared to the processing of generating the receipt screen illustrated in FIG. 11, S203, S204, and S206 are omitted in the processing of generating the receipt screen according to the modified example. If the payer account information is not acquired at S202, at S205, data of the receipt screen is generated so as to include information indicating that the payer account information is not registered, instead of including the payer account information on the screen.

Receipt Screen

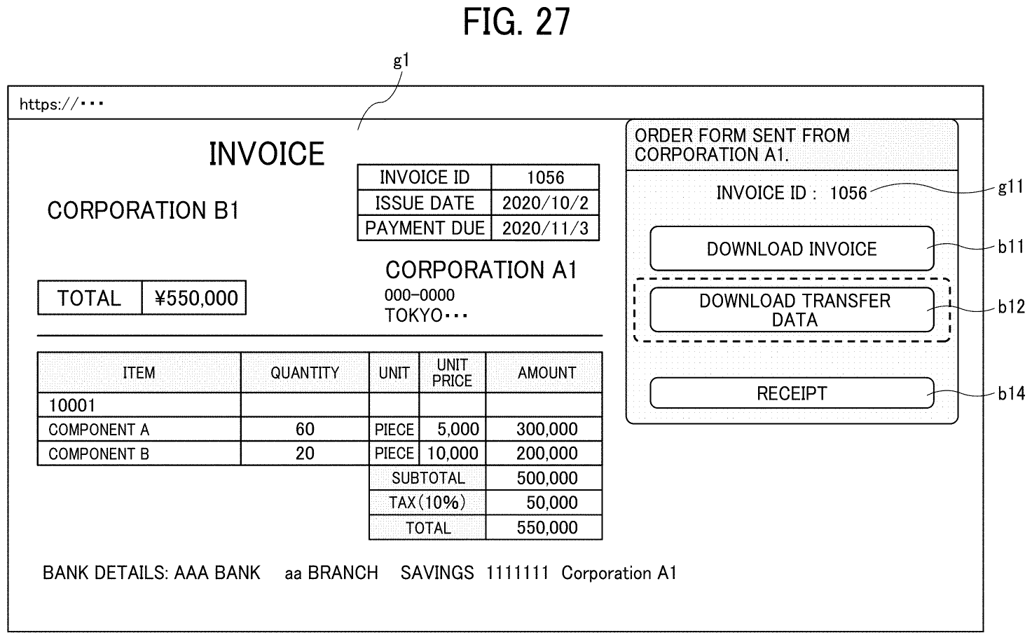

FIG. 27 is a diagram illustrating an example of a receipt screen according to the modified example. In the above-described embodiment, the receipt screen illustrated in FIG. 12 or the receipt screen illustrated in FIG. 13 is displayed depending on whether or not the payer account information has been registered, but in this modified example, the receipt screen illustrated in FIG. 27 is displayed in either case.

Processing to Download Transfer Data

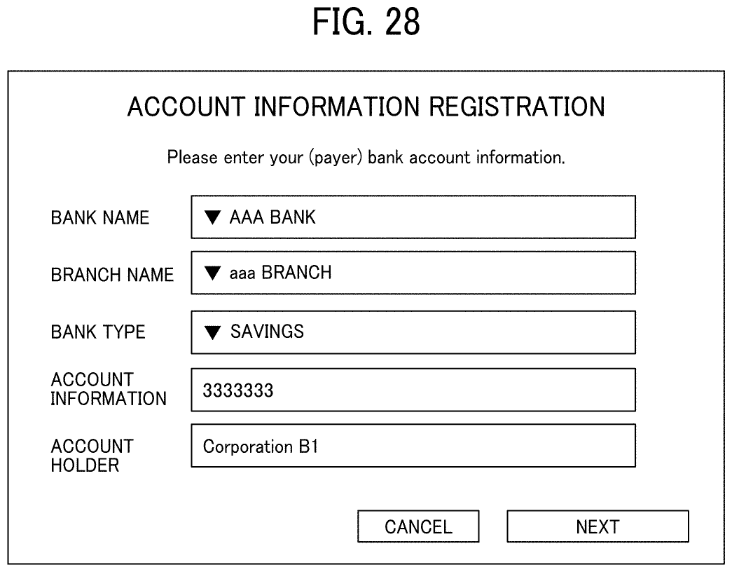

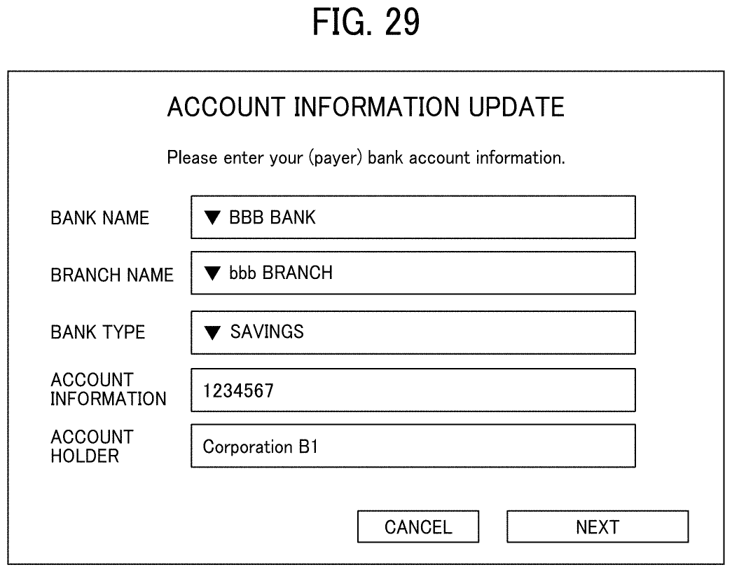

As compared with the receipt screen illustrated in FIG. 12, the receipt screen according to the modified example is different in operation that is performed in response to pressing of the transfer data download button b12. When the acceptance unit 22 receives the operation of clicking the invoice download button b12 displayed on the receipt screen, the display control unit 24 displays an account information registration screen as illustrated in FIG. 28 or an account information update screen as illustrated in FIG. 29 on the display 106.

When the payer account information is read, that is, when the payer account information is included in the data of the receipt screen, the display control unit 24 displays the account information update screen. On the other hand, when the payer account information has not been read out, that is, when information indicating that the payer account information is not registered is included in the data of the receipt screen, the display control unit 24 displays an account information registration screen.

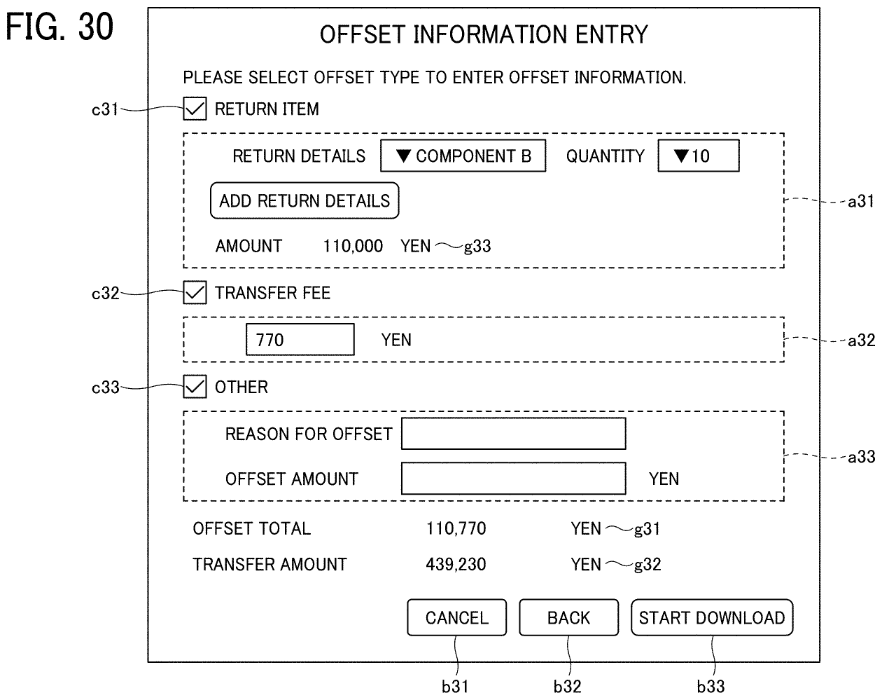

FIG. 28 is a diagram illustrating an example of an account information registration screen according to the modified example. Compared with the account information registration screen illustrated in FIG. 18, the account information registration screen of FIG. 28 displays a “next” button instead of the download start button. When the acceptance unit 22 receives operation of clicking the “next” button displayed on the account information registration screen, the display control unit 24 displays an offset information input screen as illustrated in FIG. 30 on the display 106.

FIG. 29 is a diagram illustrating an example of an account information update screen according to the modified example. Compared with the account information update screen illustrated in FIG. 19, the account information update screen of FIG. 29 displays a “next” button instead of the download start button. When the acceptance unit 22 receives operation of clicking the “next” button displayed on the account information update screen, the display control unit 24 displays an offset information input screen as illustrated in FIG. 30 on the display 106.

FIG. 30 is a diagram illustrating an example of an offset information input screen according to the modified example. As illustrated in FIG. 30, the offset information input screen includes check boxes c31 to c33 for selecting an offset type, entry fields a31 to a33 for entering offset details corresponding to each offset type, a total offset amount display field g31, a transfer amount display field g32, a cancel button b31, a back button b32, and a download start button b33.

Among these, the entry fields a31 to a33 are not displayed at the time of initial display of the offset information input screen. When at least one of the check boxes c31 to c33 is checked, an entry field corresponding to the checked box is displayed. For example, when the check box a31 to be selected for the return item is checked, the entry filed a31 for entering details of the return item is displayed.

Details on the returned item can be then entered in the entry field a31. The details on the returned item may be in a form in which the item name and the quantity are directly input. Alternatively, the details on the returns item may be displayed with a pull-down list, which is generated based on the detail information included in the invoice, for selection by the buyer B1. The entry field a31 further displays a total amount g33 of offset by the returned item, which is automatically calculated.

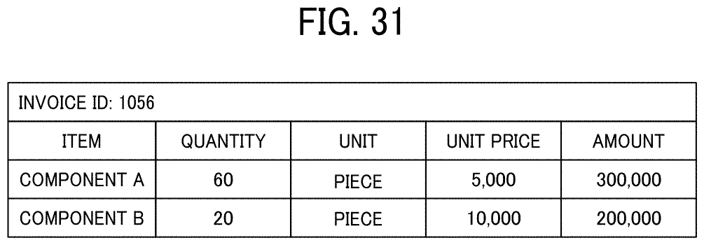

In order to include the pull-down list in the entry field a31, the detail information included in the invoice may be stored in association with the invoice information. FIG. 31 is a conceptual diagram illustrating an invoice detail information management table. The storage unit 3000 stores an invoice detail information management DB 3005, such as the invoice detail information management table as illustrated in FIG. 31. The table stores, for each invoice ID, an item, quantity, unit, unit price, and total amount, in association.

When the acceptance unit 22 receives operation of clicking the download start button b33 on the offset information input screen, the transmission and reception unit 21 of the buyer terminal 2 transmits, to the transaction management server 3, a transfer data download request, account information input via the account information registration screen or the account information update screen, offset information entered via the offset information input screen, and an invoice ID.

When the acceptance unit 22 receives operation of clicking the cancel button b31 on the offset information input screen, the display control unit 24 displays a receipt screen. When the acceptance unit 22 receives operation of clicking the back button b32 on the offset information input screen, the display control unit 24 displays the account information registration screen or the account information update screen, which has been displayed before display of the offset information input screen.

At the transaction management server 3, the storing and reading processing unit 39 stores the transmitted account information in the payer account information management DB 3002. Further, the storing and reading processing unit 39 stores the transmitted offset information in the invoice information management DB 3003.

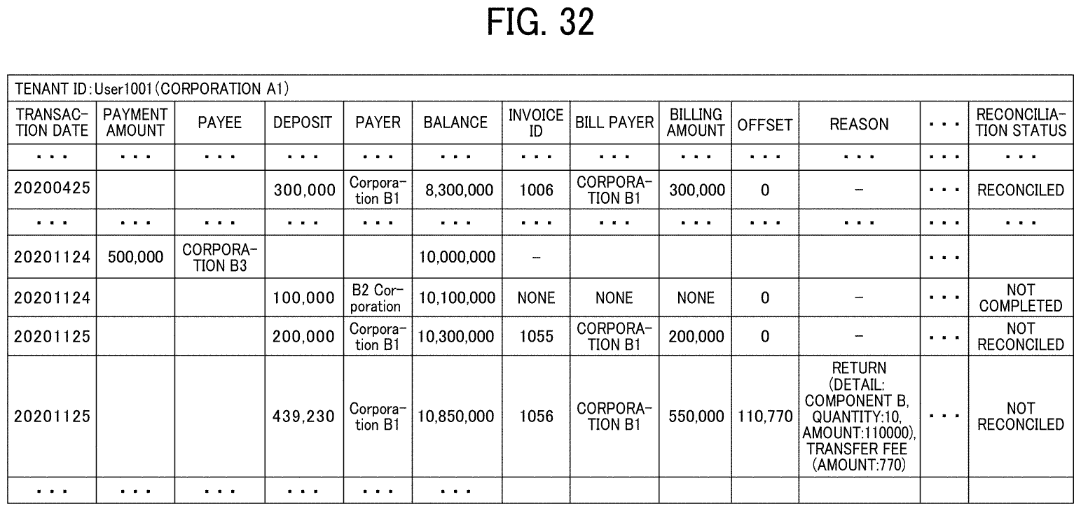

FIG. 32 is a conceptual diagram illustrating an example of invoice information management table, according to the modified example. Compared to the invoice information management table of FIG. 7, the invoice information management table according to this modified example further includes an offset amount and a reason for offset.

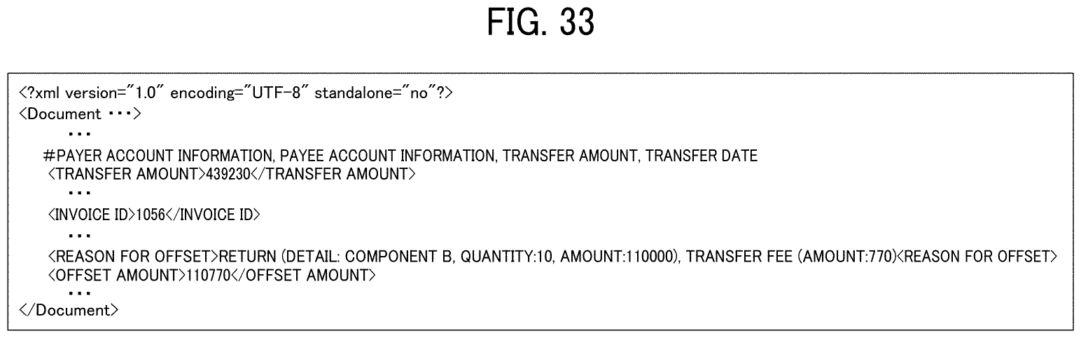

FIG. 33 is a diagram illustrating an example of transfer data, according to the modified example. As illustrated in FIG. 33, the transfer data in the modified example includes a reason for offset and an amount of offset. The transfer amount is an amount obtained by subtracting the offset amount from the billing amount on the invoice.

Processing to Reconcile Transactions

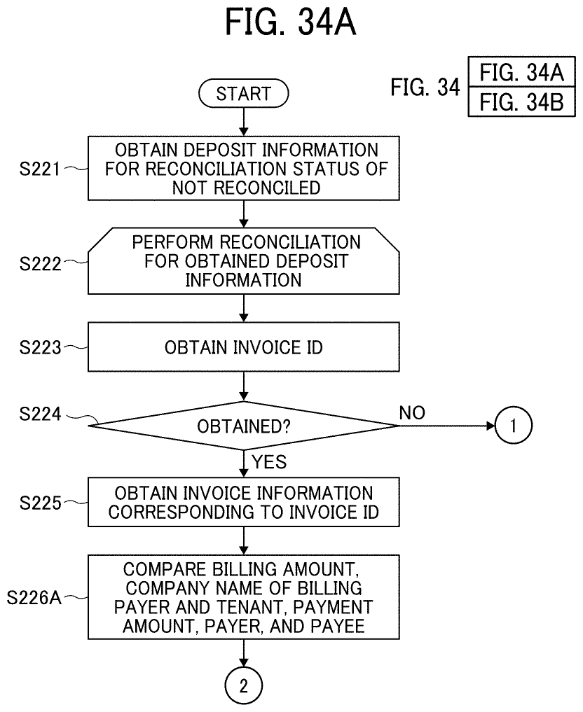

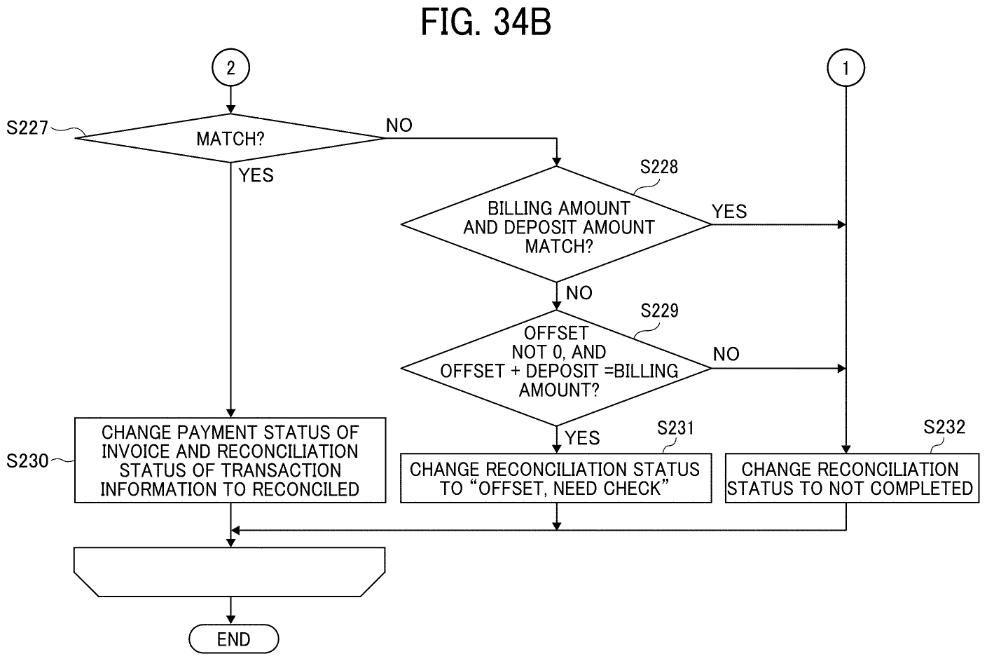

FIGS. 34A and 34B (FIG. 34) are a flowchart illustrating automatic reconciliation process according to the modified example. The automatic reconciliation process according to the modified example differs from the automatic reconciliation process illustrated in FIG. 24 in that S226 is replaced by S226A, and S228, S229, and S231 are added.

Hereinafter, only the difference from the automatic reconciliation process of FIG. 24 will be described. The determination unit 35 compares the billing amount, the company name of the bill payer, and the company name of the tenant (biller), included in the invoice information with the deposit amount, the payer, and the payee included in the transaction (transfer) information (S226A). In a case where any one of the billing amount, the company name of the bill payer, and the company name of the tenant, included in the invoice information does not match corresponding one of the deposit amount, the payer, and the payee included in the transaction (transfer) information (S227: NO), the billing amount included in the invoice information is compared with the deposit amount included in the transaction (transfer) information (S228).

When the billing amount and the deposit amount match (S228: YES), the storing and reading processing unit 39 changes the reconciliation status of the transaction (transfer) information from “not reconciled” to “not completed” (S232). On the other hand, when the billing amount and the deposit amount do not match (S228: NO), the determination unit 35 determines whether or not the offset amount included the invoice information is 0, and whether or not a sum of offset amount and deposit amount matches the billing amount (S229).

When the offset amount included in the invoice information is not 0 and the sum of offset amount and deposit amount matches the billing amount (S229: YES), the storing and reading processing unit 39 changes the reconciliation status of the transaction (transfer) information from “not reconciled” to “offset, need check” (S231). On the other hand, when the offset amount included in the invoice information is 0 or the sum of offset amount and the deposit amount does not match the billing amount (S229: NO), the storing and reading processing unit 39 changes the reconciliation status of the transaction (transfer) information from “not reconciled” to “not completed” (S232).

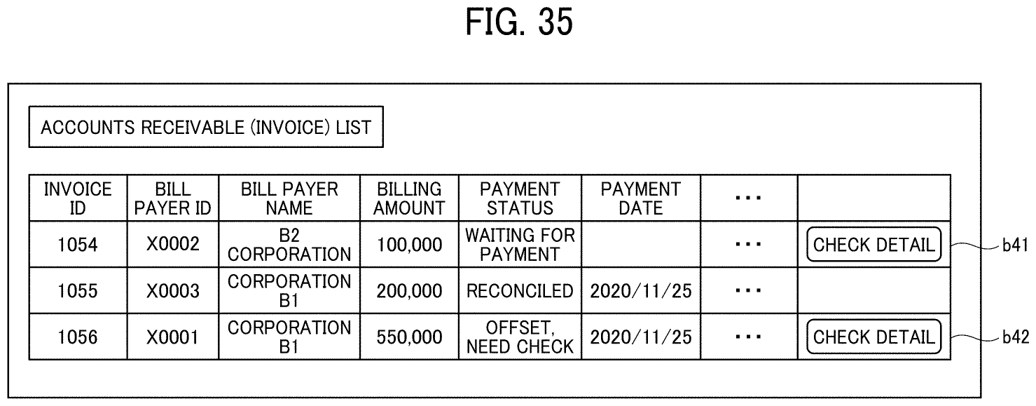

FIG. 35 is a diagram illustrating an example of an automatic reconciliation result screen according to the modified example. Compared to the automatic reconciliation result screen of FIG. 25, the automatic reconciliation result screen according to the modified example further includes detail check buttons b41 and b42 each corresponding to a particular invoice for which reconciliation has not been completed.

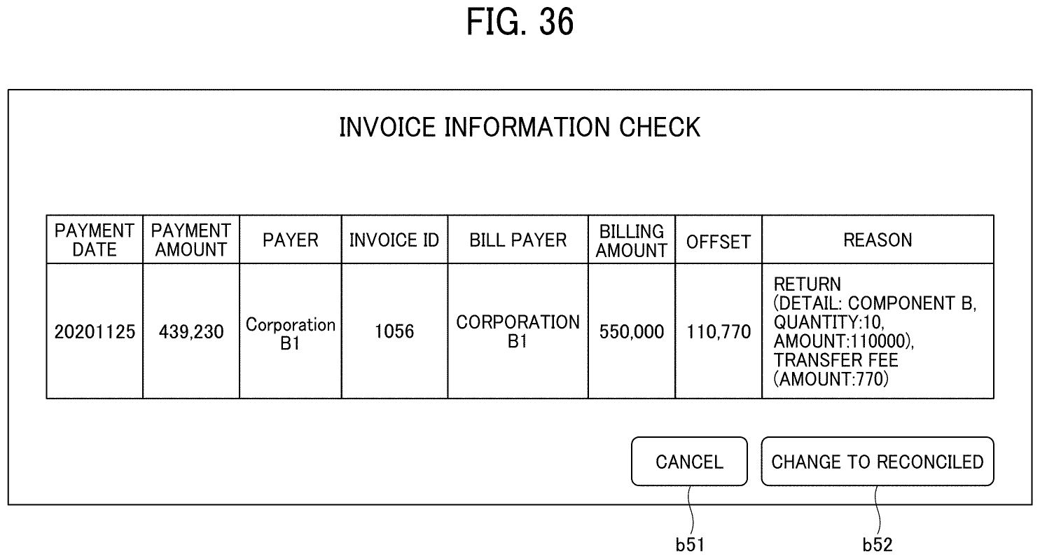

When the acceptance unit 22 receives operation of clicking any of the detail check buttons b41 and b42 on the automatic reconciliation result screen, the display control unit 24 displays an invoice information check screen, for example, as illustrated in FIG. 36 on the display 106.

FIG. 36 is a diagram illustrating an example of invoice information check screen according to the modified example, when the check button b42 is selected. As illustrated in FIG. 36, the invoice information check screen includes a plurality of items such as a payment date, a payment amount, a payer, an invoice ID, a bill payer, a billing amount, an offset amount, and a reason for offset. The invoice information check screen further includes a cancel button b51 and a reconciliation completion button b52.

When the acceptance unit 22 receives operation of clicking the reconciliation completion button b52 on the invoice information check screen, the transmission and reception unit 21 of the buyer terminal 2 transmits a reconciliation request and an invoice ID to the transaction management server 3. At the transaction management server 3, the storing and reading processing unit 39 changes the payment status of the invoice information in the invoice information management DB 3003 from “waiting for payment” to “reconciled”. The storing and reading processing unit 39 further changes the reconciliation status of the transaction (transfer) information in the transaction information management DB 3004 from “offset, need check” to “reconciled”.

When the acceptance unit 22 receives operation of clicking the cancel button b51 on the invoice information check screen, the display control unit 24 displays the automatic reconciliation result screen.

Second Variation: Transfer of a Plurality of Invoices

In a case where a plurality of invoices are issued from the same billing source, it is common practice to transfer a sum of billing amounts indicated by the invoices by one transfer, to reduce the transfer fee. The following describes a modified example in which billing amounts indicated by a plurality of invoices are transferred at once.

Processing to Display Receipt Screen

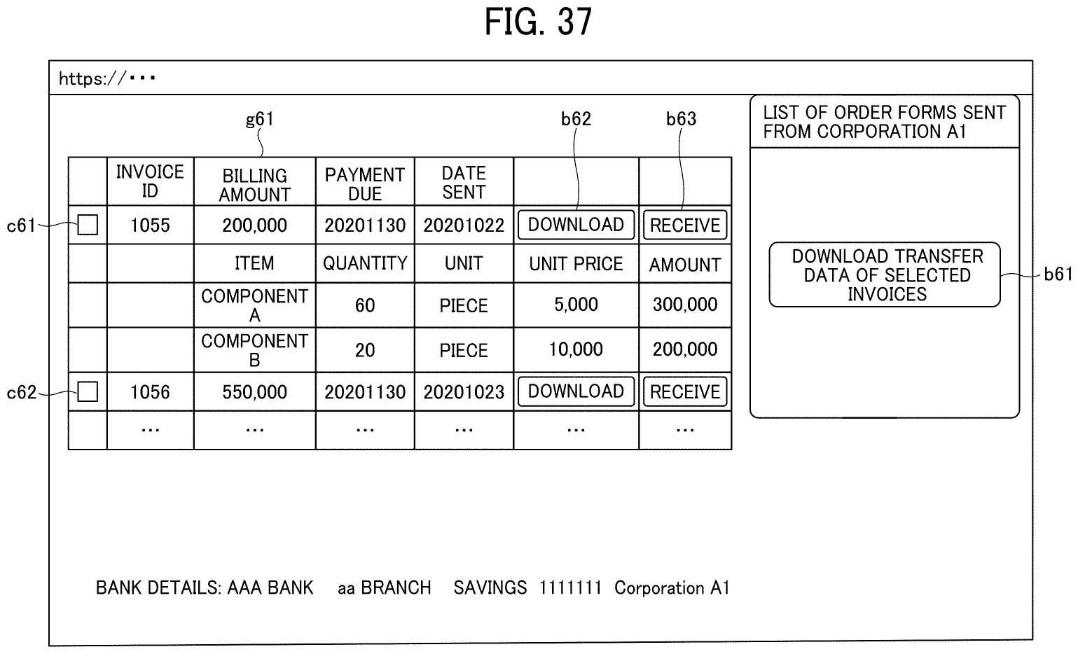

At the buyer terminal 2, in response to the buyer B1 operating the buyer terminal 2 to select a link to the receipt screen generated for a particular business partner (in this example, the seller), the acceptance unit 22 receives a request for accessing the link. For example, the link to the receipt screen specific to the corporation A1, which is illustrated in FIG. 37, may be selected. The link to the receipt screen specific to a particular seller is previously generated for each seller, and is stored in association with the bill payer ID in the invoice information management DB 3003, for example. The transmission and reception unit 31 of the transaction management server 3 transmits, to the buyer terminal 2, an email, which contains URL of the receipt screen of the invoice that is generated and URL of the receipt screen specific to a particular seller that issues that invoice.

In response to the acceptance unit 22 receiving operation to open the link of the receipt screen for the particular seller, the transmission and reception unit 21 of the buyer terminal 2 transmits a request for screen data of the receipt screen for the particular seller to the transaction management server 3. Next, at the transaction management server 3, the generation unit 36 generates a receipt screen for the particular seller in response to the request for the receipt screen for the particular seller.

Processing to Generate Receipt Screen

The storing and reading processing unit 39 searches the invoice information management DB 3003 using the URL of the receipt screen for the particular seller, which is requested, as a search key, to read the corresponding bill payer ID. Next, the storing and reading processing unit 39 searches the invoice information management DB 3003 using the bill payer ID that is read as a search key, to read the invoice information on the invoice issued to the payer by the particular seller.

The generation unit 36 generates data of a receipt screen for the particular seller, which includes the invoice information that is read. Subsequently, the transmission and reception unit 31 of the transaction management server 3 transmits the generated data of the receipt screen to the buyer terminal 2.

Receipt Screen Specific to Business Partner

FIG. 37 is a diagram illustrating an example of a receipt screen specific to a particular business partner (seller) according to the modified example. As illustrated in FIG. 37, the receipt screen for the particular seller includes an invoice list display field g61, check boxes c61 to c62 for selecting an invoice, and a transfer data download button b61.

Among these items, the invoice list display field g61 includes items such as an invoice ID, a billing amount, a payment due date, and a date sent. Further, the respective items of this invoice information are displayed in association with detail information such as an item, quantity, unit, unit price, total amount, etc. Further, for each item of invoice information, an invoice download button b62 and a receipt button b63 are displayed.

Among these buttons, the transfer data download button b61 is a button for downloading transfer data to the buyer terminal 2, which includes an invoice ID of an invoice having its check box (c61 or c62) checked. The invoice download button b62 is a button for allowing the buyer B1 to download the invoice image to the buyer terminal 2. The receipt button b63 is a button for allowing the buyer B1 to notify the seller that the invoice has been received.

Processing to Download Transfer Data

When the acceptance unit 22 receives operation of clicking the transfer data download button b61 on the receipt screen for the particular seller, the transmission and reception unit 21 of the buyer terminal 2 transmits a transfer data download request, account information entered via the account information registration screen or the account information update screen, and a plurality of invoice IDs selected via the receipt screen for the particular seller, to the transaction management server 3.

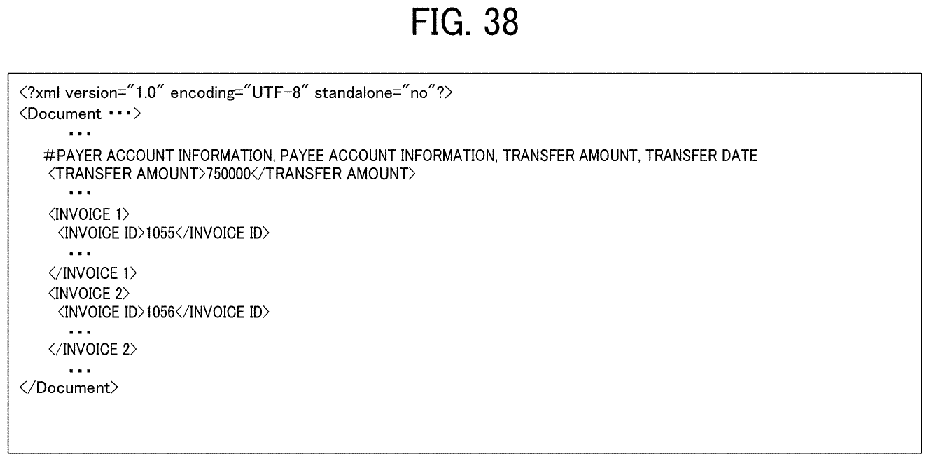

FIG. 38 is a diagram illustrating an example of transfer data, according to the modified example. As illustrated in FIG. 38, the transfer data in the modified example includes a plurality of items of invoice information (invoice 1, invoice 2.). The transfer amount is a sum of the billing amounts on the invoices included in the transfer data.

Processing to Reconcile Transactions

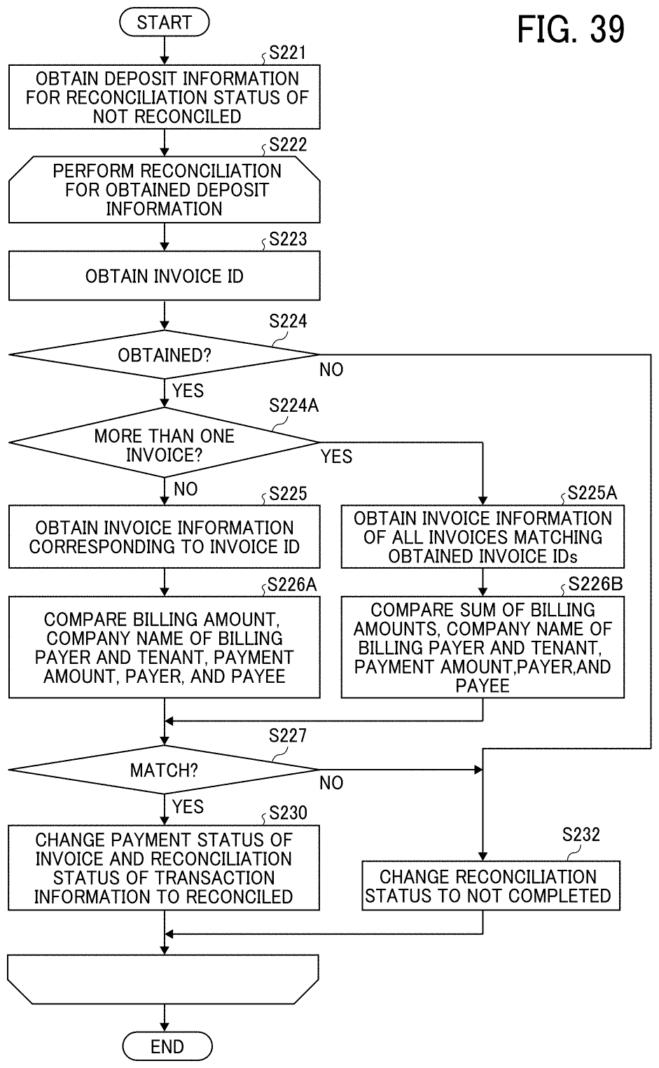

FIG. 39 is a flowchart illustrating automatic reconciliation process according to the modified example. The automatic reconciliation process according to the modified example differs from the automatic reconciliation process illustrated in FIG. 24 in that S226 is replaced by S226A, and S224A, S225A, and S226B are added.

Hereinafter, only the difference from the automatic reconciliation process of FIG. 24 will be described. When there is a plurality of invoice IDs acquired by the determination unit at S223 (S224A: YES), the storing and reading processing unit 39 searches the invoice information management DB 3003 using each invoice ID as a search key, to acquire all items of invoice information each corresponding to the acquired invoice ID (S225A).

Next, the determination unit 35 compares the total billing amount, the company name of the bill payer, and the company name of the tenant, included in the invoice information, respectively, with the deposit amount, the payer, and the payee, included in the transaction (transfer) information (S226B).

When the total billing amount, the company name of bill payer, and the company name of the tenant, included in the invoice information, respectively match the payment amount, the payer, and the payee, included in the transaction (transfer) information (S227: YES), the storing and reading processing unit 39 changes the payment status of the invoice information in the invoice information management DB 3003 from “waiting for payment” to “reconciled”, and changes the reconciliation status of the transaction (transfer) information in the transaction information management DB 3004 from “not reconciled” to “reconciled” (S230).

On the other hand, in a case where any one of the total billing amount, the company name of the bill payer, and the company name of the tenant does not match corresponding one of the deposit amount, the payer, and the payee included in the transaction (transfer) information (S227: NO), the storing and reading processing unit 39 changes the reconciliation status of the transaction (transfer) information from “not reconciled” to “not completed” (S232). The operation then ends.

Third Variation:

Combination of Modified Examples The above-described modified examples may be combined, such that offset information may be reflected when transferring payment corresponding to a plurality of invoices. In this case, offset information can be entered for each invoice on the offset information input screen.

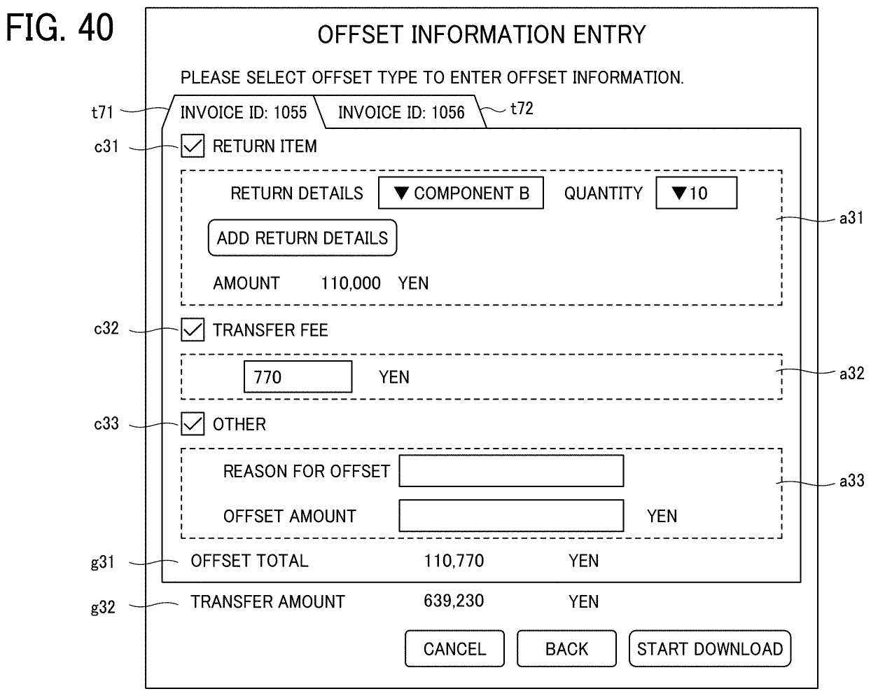

FIG. 40 is a diagram illustrating an example of offset information input screen in a case where the example in the first variation and the example in the third variation are combined. As illustrated in FIG. 40, the offset information input screen according to this modified example includes tabs t71 and t72 corresponding to the invoice information selected on the receipt screen for the particular seller. The tabs t71 and t72 have the same configuration and each include check boxes c31 to c33 for selecting an offset type, entry fields a31 to a33 for entering offset details corresponding to each offset type, a total offset amount display field g31, and a transfer amount display field g32.

Among these, the total offset amount display field g31 displays therein a sum of offset amounts each entered in the tab. The transfer amount display field g32 displays therein an amount obtained by subtracting the sum of offset amounts of the tabs, from the sum of the billing amounts of invoice information.

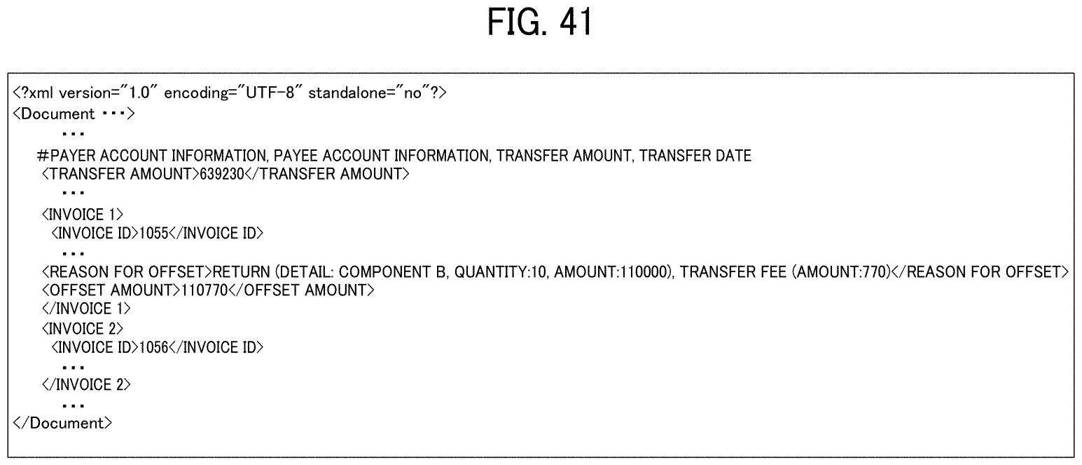

FIG. 41 is a diagram illustrating an example of transfer data, according to the modified example. As illustrated in FIG. 41, the transfer data in the modified example includes a plurality of items of invoice information (invoice 1, invoice 2.). Further, each invoice information includes a reason for offset and an amount of offset. The transfer amount is an amount obtained by subtracting the sum of offset amounts, from the sum of billing amounts in the invoices included in the transfer data.

As described above, according to the one or more embodiments described above, the transaction management server 3 that manages a plurality of invoices in relation to transactions between a seller and a buyer generates transfer data (see FIG. 21). The transfer data includes invoice identification information for identifying an invoice issued to the buyer in transaction, and used for transfer (see S3) from an account of the buyer to an account of the seller based on the invoice. The transaction management server 3 transmits the generated transfer data to a buyer terminal of the buyer (see S143). In this manner, a form (i.e., invoice) corresponding to the transfer data from the buyer can be identified, using the identification information for identifying the form. This reduces the workload on reconciliation processing.

The seller terminal 1 is an example of a communication terminal. Examples of the seller terminal 1 include, in addition to the PC, a smart watch, a game machine, and a video conference system.

Some Hardware Elements, Such as the CPU 101, May be Single or Plural.

Each of the functions of the above-described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), System on a chip (SOC), graphical processing unit (GPU), and conventional circuit components arranged to perform the recited functions.

The servers 3, 5, and 7 described in the embodiment are merely one example of plural computing environments that implement one or more embodiments disclosed herein. For example, the transaction management server 3 may include a plurality of computing devices such as a server cluster. The plurality of computing devices are configured to communicate with one another through any type of communication link, including a communication network, a shared memory, etc., and perform processes disclosed herein. In substantially the same manner, the transaction management server 3 can include a plurality of computing devices configured to communicate with one another.

Further, the transaction management server 3 can be configured to share the disclosed processes with any server in various combinations. For example, a part of processes to be executed by the transaction management server 3 can be executed by any other server. Similarly, a part of functions to be executed by the transaction management server 3 can be performed by any other server. Further, the elements of the transaction management server 3 and any other server may be combined into one apparatus or may be divided into a plurality of apparatuses.

Furthermore, in communication between each terminal and each server (such as communication between any one of the seller terminal 1, the buyer terminal 2, the transaction management server 3, the account management server 4a, and the account management server 4b), any intermediary device such as another server or a router may be disposed to relay data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

In one aspect, a transaction management server manages a plurality of invoices each indicating a transaction between a seller and a buyer. The server includes circuitry that generates transfer data indicating a transfer from an account of the buyer to an account of the seller, which includes an identifier of a particular invoice issued by the seller. The circuitry of the server transmits the transfer data to a buyer terminal operated by the buyer.

In another aspect, the circuitry of the server further receives transfer record information indicating the transfer from the account of the buyer to the account of the seller, from an account management server managing the account of the buyer. The circuitry of the server reconciles the particular invoice based on information on the particular invoice identified with the identifier included in the transfer data, and the transfer record information including the identifier of the particular invoice.

In another aspect, the circuitry of the server receives information on contents of the particular invoice from the seller terminal operated by the seller, and generates the transfer data based on the content of the particular invoice. The contents include, for example, an amount of transfer, an identifier of the first user, and an identifier of the second user.

In another aspect, the circuitry of the server generates the transfer data including an identifier of each of a plurality of invoices. The circuitry of the server reconciles each particular invoice, identified with a corresponding identifier of the plurality of identifiers included in the transfer data, which matches a corresponding identifier of the plurality of identifiers included in the transfer record information.

In another aspect, the circuitry of the server generates the transfer data based on the content of the particular invoice, which includes offset information in relation to the particular invoice. The circuitry of the server receives the transfer record information including the identifier of the particular invoice, and the offset information. The circuitry of the server reconciles the particular invoice, based on a determination of whether the offset information matches, between the transfer data and the transfer record information.

In another aspect, the circuitry of the server further receives a request for transmitting an address used by the buyer to obtain the invoice, from the seller terminal of the seller, and transmits the address for obtaining the invoice to the buyer in response to the request. The circuitry further transmits data of a receipt screen used by the buyer to obtain the transfer data including the identifier of the particular invoice, to the buyer terminal in response to an access to the address from the buyer terminal.

In another aspect, the identifier of the particular invoice may be represented by any one of combination including characters, numbers, symbols, marks etc.

In another aspect, a communication system is provided, which includes the transaction management server, and the buyer terminal that receives the transfer data from the transaction management server.

In another aspect, a method is performed by a transaction management server that manages a plurality of invoices each indicating a transaction between a seller and a buyer. The method includes generating transfer data indicating a transfer from an account of the buyer to an account of the seller, which includes an identifier of a particular invoice issued by the seller; and transmitting the transfer data to a buyer terminal operated by the buyer.

In another aspect, a non-transitory recording medium which, when executed by one or more processors, cause the processors to perform a method including: generating transfer data indicating a transfer from an account of a buyer to an account of a seller, which includes an identifier of a particular invoice issued by the seller: and transmitting the transfer data to a buyer terminal operated by the buyer.

1. A server apparatus comprising:
a memory that stores information on a plurality of forms issued by a first user; and
circuitry configured to
generate transfer data indicating a transfer of an item from a second user to the first user based on a particular form of the plurality of forms, the transfer data including an identifier of the particular form, and
transmit the transfer data to a second terminal operated by the second user to cause the second user to transfer the item to the first user using the transfer data.

2. The server apparatus of claim 1, wherein
the circuitry is further configured to receive, from another server that stores information on items of the first user, transfer record information confirming the transfer of the item from the second user to the first user, the transfer record information including the identifier of the particular form, and
determine whether the identifier of the particular form included in the transfer data, matches the identifier of the particular form included in the transfer record information.

3. The server apparatus of claim 1, wherein
the circuitry is further configured to receive information regarding the item to transfer from the first user terminal operated by the first user, and
generate the form to include the information regarding the item, and the transfer data including the identifier of the form having been generated.

4. The server apparatus of claim 3, wherein
the circuitry is further configured to determine whether the information regarding the item, included in the particular form identified with the identifier, matches the transfer record information identified with the identifier, and
store a determination result indicating whether the information regarding the item matches.

5. The server apparatus of claim 3, wherein
the information regarding the item includes an amount of the item, an identifier of the first user, and an identifier of the second user, and
the form is generated to include the amount of the item, the identifier of the first user, and the identifier of the second user.

6. The server apparatus of claim 5, wherein
the information regarding the item further includes a modification to the amount of the item, and
the form is generated to include the modification to the amount of the item.

7. The server apparatus of claim 1, wherein the particular form includes a plurality of particular forms.

8. The server apparatus of claim 3, wherein
the circuitry is further configured to, in response to a request from the first user, transmit a user interface that allows the second user to obtain the form having been generated, the user interface including the identifier of the particular form.

9. A system comprising:
the server apparatus of claim 1; and
the second terminal configured to receive the transfer data from the server apparatus, and request transfer of the item to the first user using the transfer data.

10. A system comprising:
a memory that stores information on a plurality of forms issued by a first user; and
circuitry configured to
generate transfer data indicating a transfer of an item from a second user to the first user based on a particular form of the plurality of forms, the transfer data including an identifier of the particular form, and
transmit the transfer data to a second terminal operated by the second user to cause the second user to transfer the item to the first user using the transfer data.

11. An information processing method, comprising:
storing information on a plurality of forms issued by a first user;
generating transfer data indicating a transfer of an item from a second user to the first user based on a particular form of the plurality of forms, the transfer data including an identifier of the particular form; and
transmitting the transfer data to a second terminal operated by the second user to cause the second user to transfer the item to the first user using the transfer data.

12. The method of claim 11, further comprising:
receiving, from another server that stores information on items of the first user, transfer record information confirming the transfer of the item from the second user to the first user, the transfer record information including the identifier of the particular form; and
determining whether the identifier of the particular form included in the transfer data, matches the identifier of the particular form included in the transfer record information.

13. The method of claim 11, further comprising:
receiving information regarding the item to transfer from the first user terminal operated by the first user; and
generating the form to include the information regarding the item, and the transfer data including the identifier of the form having been generated.

14. The method of claim 13, further comprising:
determining whether the information regarding the item, included in the particular form identified with the identifier, matches the transfer record information identified with the identifier; and
storing a determination result indicating whether the information regarding the item matches.
